(19) United States
(12) Patent Application Publication
(10) Pub. No.: US 2026/0109273 A1
(43) Pub. Date: Apr. 23, 2026

(54) ADAPTIVE ROBOT FOR VEHICLES

(71) Applicant: GQY DREAM TECHNOLOGY COMPANY INC., NEW YORK, NY (US)

(72) Inventors: Qiyin GUO, Zhejiang (CN); Jiangdong YANG, Zhejiang (CN); Lin SHEN, Zhejiang (CN); Xinjian NIU, Zhejiang (CN); Miao CHEN, Zhejiang (CN); Nan HU, Zhejiang (CN); Pingying WEI, Zhejiang (CN)

(73) Assignee: GQY DREAM TECHNOLOGY COMPANY INC., NEW YORK, NY (US)

(21) Appl. No.: 19/232,890

(22) Filed: Jun. 10, 2025

(30) Foreign Application Priority Data
Oct. 18, 2024 (CN) 202411458269.4

(51) Int. Cl. B60N 2/02; B60N 2/10; B60N 2/50; F16F 15/02; F16H 37/12

(52) U.S. Cl. CPC B60N 2/0277; B60N 2/02246; B60N 2/10; B60N 2/501; B60N 2/502; F16F 15/02; F16H 37/122

(57) ABSTRACT

An adaptive robot for vehicles is provided, including an active centrifugal force counteracting structure and a controller. The active centrifugal force counteracting structure includes a first base plate, a support seat, a swing frame, multiple swing arms and a first screw motor assembly. The upper side of the support seat has a first mounting seat. The outer side of the swing frame has a plurality of pin shafts, one end of each swing arm is rotatably connected to one of the pin shafts of the swing frame, and the other end of each swing arm is rotatably connected to the first mounting seat. The first screw motor assembly is configured to drive the swing frame to perform rolling motion according to a first control signal sent by the controller to compensate for a centrifugal force.

### CROSS-REFERENCE TO RELATED APPLICATION

This application claims the priority benefit of Chinse application No. 202411458269.4, filed on Oct. 18, 2024. The entirety of the above-mentioned patent application is hereby incorporated by reference herein and made a part of this specification.

### BACKGROUND

### Technical Field

The disclosure mainly relates to the technical field of seat shock absorption, and in particular to an adaptive robot for vehicles.

### Description of Related Art

When a vehicle is driving, due to road factors such as potholes or speed bump, it will cause bumps, the impact caused by inertia when the vehicle brakes suddenly, and the shaking caused by centrifugal force when the vehicle turns, all of which will reduce the comfort and safety of passengers.

### SUMMARY

One aspect of the present disclosure provides a robot for vehicles, comprising an active centrifugal force counteracting structure and a controller; the active centrifugal force counteracting structure comprises a first base plate, a support seat, a swing frame, multiple swing arms and a first screw motor assembly, the lower side of the support seat is fixedly mounted on the first base plate, the upper side of the support seat has a first mounting seat, the outer side of the swing frame has a plurality of pin shafts, one end of each swing arm is rotatably connected to one of the pin shafts of the swing frame, the other end of each swing arm is rotatably connected to a first mounting seat, the first screw motor assembly is mounted on the first base plate and has a first screw motor, the movable end of the first screw motor assembly is connected to the swing frame, and the first screw motor assembly is used to drive the swing frame to perform rolling motion according to a first control signal emitted by the controller to compensate for centrifugal force; the controller is configured to: obtain a current vehicle posture state data, and judging the driving scene of the vehicle according to the vehicle posture data, and when the driving scene is a sharp turn, issuing the first control signal, the first control signal including the expected speed of the first screw motor; wherein the controller calculates the expected speed of the first screw motor including: calculating the expected compensation angle of centrifugal force according to the driving scene and the vehicle posture data; calculating the angle between the first swing arm located on one side of the swing frame and the ground according to the expected compensation angle and the kinematic equation of the active centrifugal force counteracting structure; calculating the moving pair length of the first screw motor assembly according to the angle between the first swing arm and the ground and the installation position of the first screw motor; calculating the expected speed of the first screw motor according to the moving pair length of the first screw motor assembly, the angle between the first swing arm and the ground and the expected compensation angle.

One aspect of the present disclosure provides a robot for a vehicle, comprising an inertial force counteracting structure and a controller. The inertial force counteracting structure comprises: a second base plate, a pitch shaft seat, a pitch shaft and a second screw motor assembly; the second base plate and the first base plate are rotationally connected through the pitch shaft seat and the pitch shaft, the fixed end of the second screw motor assembly is connected to the second base plate, the movable end of the second screw motor assembly is connected to the first support seat, and the first support seat is fixedly connected to the first base plate; the second screw motor assembly is used to drive the active centrifugal force counteracting structure to perform pitch motion according to the second control signal. The controller is configured to send a second control signal when the driving scene is emergency braking or emergency acceleration, and the inertial force counteracting structure is used to drive the carrier to perform pitch motion according to the second control signal to absorb the inertial force.

One aspect of the present disclosure provides a robot for a vehicle, comprising an inertial force counteracting structure and a controller. The inertial force counteracting structure comprises a second base plate, a base plate shaft seat, a third screw motor assembly, a first pitch swing arm, a second pitch swing arm, a first swing arm shaft seat and a second swing arm shaft seat, the second base plate and the first base plate are rotatably connected through the base plate shaft seat, the screw motor assembly is arranged on the first base plate or the second base plate, the first swing arm shaft seat is arranged on the first base plate, the second swing arm shaft seat is arranged on the second base plate, the first pitch swing arm is connected between the screw motor assembly and the first swing arm shaft seat, and the second pitch swing arm is connected between the screw motor assembly and the second swing arm shaft seat. The controller is also configured to send a second control signal when the driving scene is emergency braking or emergency acceleration, and the inertial force counteracting structure is used to drive the carrier to do pitch motion according to the second control signal to absorb the inertial force.

One aspect of the present disclosure provides a semi-active shock absorbing structure, which is arranged on the active centrifugal force counteracting structure, and the semi-active shock absorbing structure includes a scissors mechanism, a lower swing arm, an upper swing arm and a seat mounting bracket, wherein: the scissors mechanism includes an outer cross arm and an inner cross arm, the lower swing arm includes a first rotation pair and a second rotation pair, and the upper swing arm includes a third rotation pair and a fourth rotation pair; the lower end of the inner cross arm is connected to the swing frame, the lower end of the outer cross arm is connected to the first rotation pair of the lower swing arm, and the second rotation pair of the lower swing arm is connected to the swing frame; the upper end of the outer cross arm is connected to the seat mounting bracket, the upper end of the inner cross arm is connected to the third rotation pair of the upper swing arm, the fourth rotation pair of the upper swing arm is connected to the seat mounting bracket, and the seat mounting bracket is used to install the seat surface.

### BRIEF DESCRIPTION OF THE DRAWINGS

The accompanying drawings are included to provide a further understanding of the present disclosure. They are included and constitute a part of the present disclosure. The accompanying drawings illustrate embodiments of the present disclosure and together with the present specification serve to explain the principles of the present disclosure. In the accompanying drawings:

FIG. 1 is a schematic diagram of a vehicle seat according to an embodiment of the present disclosure.

FIG. 2 is a schematic diagram of the structure of a robot with an active centrifugal force counteracting structure according to an embodiment of the present disclosure.

FIG. 3 is a schematic diagram of a stationary state of the active centrifugal force counteracting structure shown in FIG. 2.

FIG. 4 is a schematic diagram of a rolling motion state of the active centrifugal force counteracting structure in FIG. 3.

FIG. 5 is a flow chart of an embodiment of a controller calculating an expected rotational speed of a first screw motor.

FIG. 6 is a kinematic diagram of the active centrifugal force counteracting structure.

FIG. 7A-7C are schematic diagrams of a vehicle seat when the active centrifugal force counteracting structure is in different states.

FIG. 8 is a schematic diagram of the dimensions of an active centrifugal force counteracting structure according to an embodiment of the present disclosure.

FIG. 9 is a schematic diagram of the structure of a robot having an inertial force counteracting structure according to an embodiment of the present disclosure.

FIG. 10 is a schematic diagram of the inertial force counteracting structure in FIG. 8.

FIG. 11A and FIG. 11B are schematic diagrams of the vehicle seat when the inertial force counteracting structure is in a stationary state and a head-up state, respectively.

FIG. 12 is a schematic diagram of the structure of the inertial force counteracting structure when it is in pitch motion.

FIG. 13 are three-dimensional schematic diagrams of a robot with an inertial force counteracting structure according to another embodiment of the present disclosure.

FIG. 14 is a side view of a robot with an inertial force counteracting structure according to another embodiment of the present disclosure.

FIG. 15 is a three-dimensional schematic diagram of the inertial force counteracting structure shown in FIG. 13 of the present disclosure.

FIG. 16 is a side view of the inertial force counteracting structure shown in FIG. 13 of the present disclosure.

FIGS. 17A and 17B are side views of an inertial force counteracting structure of another embodiment of the present disclosure.

FIG. 18 is a flow chart of a control algorithm of a controller according to an embodiment of the present disclosure.

FIG. 19 is a flow chart of an embodiment of a controller calculating an expected rotational speed of a second screw motor.

FIG. 20 is a flow chart of an embodiment of a controller calculating an expected rotational speed of the third screw motor.

FIGS. 21-23 are schematic structural diagrams of a semi-active shock absorbing structure from different viewing angles in one embodiment of the present disclosure.

FIG. 24 is a schematic diagram of a robot with a semi-active shock absorbing structure according to an embodiment of the present disclosure.

FIGS. 25A-25C are schematic diagrams of a vehicle seat when the semi-active shock absorbing structure is in different states.

FIG. 26 is a three-dimensional diagram of a semi-active shock absorbing structure according to another embodiment of the present disclosure.

FIG. 27 is an exploded view of a semi-active shock absorbing structure of another embodiment of the present disclosure.

FIG. 28 is a schematic structural diagram of a swing arm assembly in a semi-active shock absorbing structure according to another embodiment of the present disclosure.

FIG. 29 is a schematic diagram of the installation structure of the airbag in the semi-active shock absorbing structure of another embodiment of the present disclosure.

FIG. 30 is a front view of the semi-active shock absorbing structure of another embodiment of the present disclosure when it is at the highest height position.

FIG. 31 is a top view of the semi-active shock absorbing structure of another embodiment of the present disclosure when it is at the highest height position.

FIG. 32 is a front view of the semi-active shock absorbing structure of another embodiment of the present disclosure when it is located at an intermediate height position.

FIG. 33 is a top view of the semi-active shock absorbing structure of an embodiment of the present disclosure when it is located at an intermediate height position.

FIG. 34 is a front view of the semi-active shock absorbing structure of an embodiment of the present disclosure when it is at the lowest height position.

FIG. 35 is a top view of the semi-active shock absorbing structure of an embodiment of the present disclosure when it is at the lowest height position.

FIG. 36 is a schematic diagram of the robot structure with a semi-active shock absorbing structure according to another embodiment of the present disclosure.

FIG. 37 is a control principal diagram of an embodiment of the present disclosure.

### DESCRIPTION OF THE EMBODIMENTS

In order to more clearly illustrate the technical solutions of the embodiments of the present disclosure, the following is a brief introduction to the drawings required for use in the description of the embodiments. Obviously, the drawings described below are only some examples or embodiments of the present disclosure. For ordinary technicians in this field, the present disclosure can also be applied to other similar scenarios based on these drawings without creative work. Unless it is obvious from the language environment or otherwise explained, the same reference numerals in the figures represent the same structure or operation.

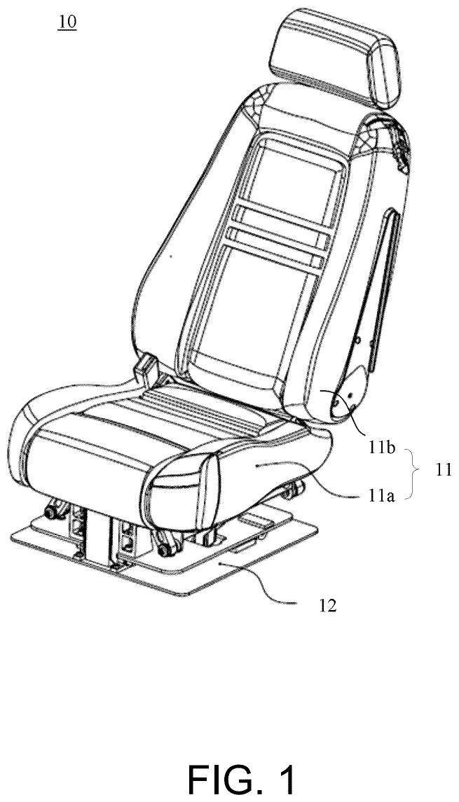

FIG. 1 is a schematic diagram of a vehicle seat according to an embodiment of the present disclosure. As shown in FIG. 1, the vehicle seat 10 includes a seat surface 11a and a seat back 11b. A robot 12 is arranged under the vehicle seat 11. The robot 12 can provide the seat 11 with active anti-sway (i.e., counteracting centrifugal force), anti-impact (i.e., counteracting inertial force) and/or shock absorption functions.

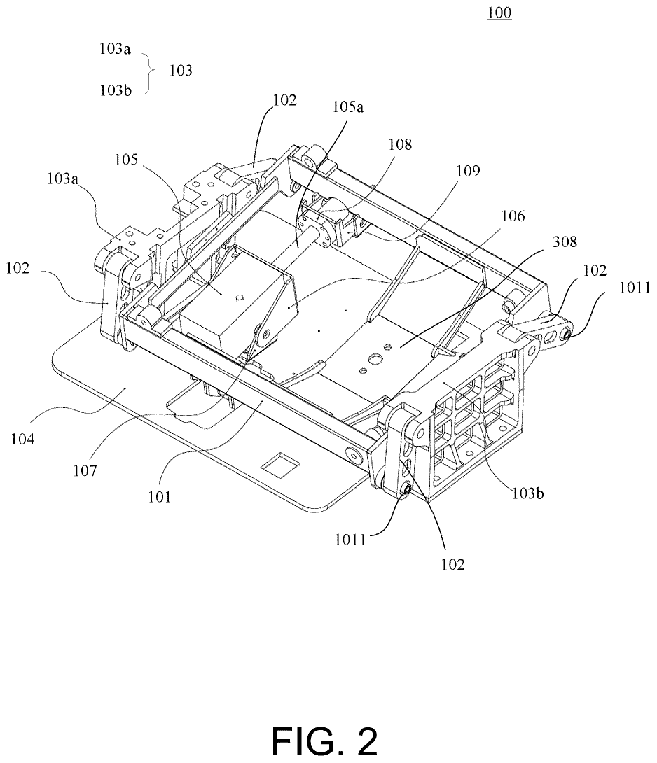

FIG. 2 shows a structural schematic diagram of an active centrifugal force counteracting structure of an embodiment of the present disclosure. As shown in FIG. 2, the active centrifugal force counteracting structure 100 includes a swing frame 101, four swing arms 102, two support seats 103, a first base plate 104, and a first screw motor assembly. Optionally, the first screw motor assembly includes a first screw motor 105, a first motor bracket 106, a first motor base 107, a first screw nut 108 and a first nut seat 109. There are four pin shafts 1011 on the outside of the swing frame 101. Two support seats 103 are mounted on the first base plate 104, wherein one end of the two rolling swing arms 102 is rotatably connected to the first support seat 103a, and the other end is rotatably connected to the pin shaft 1011 on the outside of the swing frame 101, and one end of the remaining two rolling swing arms 102 is rotatably connected to the second support seat 103a, and the other end is rotatably connected to the pin shaft 1011 on the outside of the swing frame 101. The first support seat 103a is located at the front side below the seat 11, and the second support seat 103a is located at the rear side below the seat 11. The first screw motor 105 is fixed to the first base plate 104 through the first motor base 107. The first screw motor 105 is rotatably connected to the first screw nut 108, and the first screw nut 108 is connected to the swing frame 101 through the first nut seat 109. The first screw motor 105 is used to receive the posture data of the vehicle and rotate according to the posture data. When the first screw motor 105 rotates, the screw 105a of the first screw motor 105 moves relative to the first screw nut 108, and drives the first screw nut 108 to move linearly in the direction perpendicular to the driving direction of the vehicle, pushing and pulling the swing frame 101 to roll to compensate for the centrifugal force.

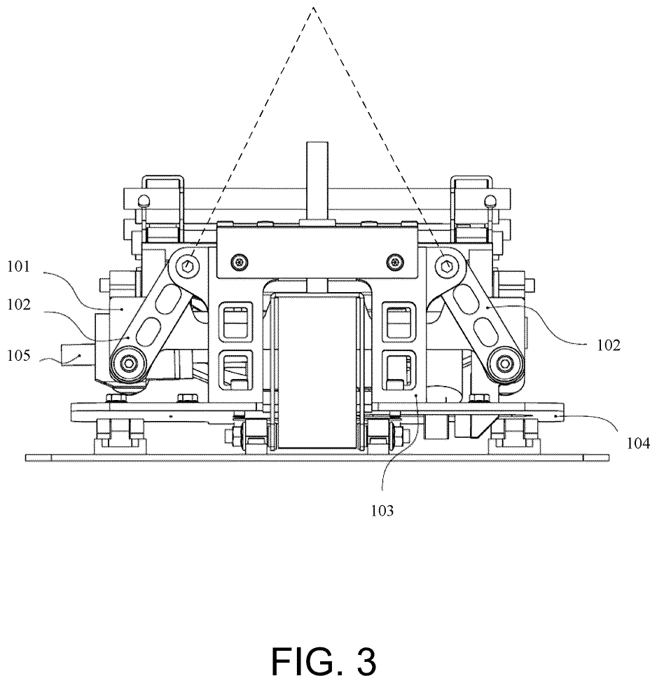

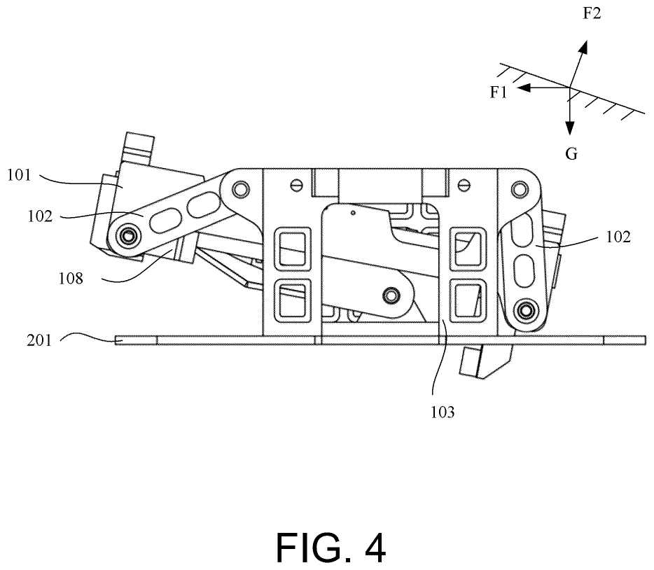

FIG. 3 is a schematic diagram of the stationary state of the active centrifugal force counteracting structure in FIG. 2. FIG. 4 is a schematic diagram of the rolling motion state of the active centrifugal force counteracting structure in FIG. 2. As shown in FIGS. 3-4, when the vehicle turns left, the passenger is subjected to the centripetal force F1. At this time, the first screw motor 105 drives the first screw 105a to move linearly relative to the first screw nut 108. The screw length between the first screw nut 108 and the first screw motor 105a increases. The first screw nut 108 pushes the swing frame 101 to rotate clockwise. At this time, the passenger is subjected to the gravity G and the support force F2 of the seat surface. The combined force of the gravity G and the support force F2 is opposite to the centripetal force F1. In other words, the active centrifugal force counteracting structure 100 actively performs rolling motion, which can counteract all or part of the centrifugal force, and can achieve a good reduction of the centrifugal force generated by the vehicle turning, thereby improving the riding comfort. On the contrary, when the vehicle turns right, the first screw motor 105 drives the first screw 105a to move linearly relative to the first screw nut 108, so that the screw length between the first screw nut 108 and the first screw motor 105 is reduced, and the first screw nut 108 pulls the swing frame 101 to rotate counterclockwise to counteract all or part of the centrifugal force.

FIG. 4 is a schematic diagram of the structure of the active centrifugal force counteracting structure when it is in a rolling motion. As shown in FIG. 4, when the active centrifugal force counteracting structure is subjected to the rightward centrifugal force F3, the first screw motor 105 drives the first screw nut 108 to move linearly along the first direction D1. In this embodiment, the rotation direction of the first screw motor 105 is to increase the length between the first screw nut 108 and the rotation axis of the first screw motor 105, and the first screw nut 108 drives the swing frame 101 to rotate in the counterclockwise direction. At this time, the swing frame 101 is in an inclined state, and the passenger is subjected to the support force F1 perpendicular to the direction of the swing frame 101 and the gravity F2 of the passenger himself. The combined force of the support force F1 and the gravity F2 is opposite to the direction of the centrifugal force F3, which can counteract part of the centrifugal force. Wherein, the screw length between the first screw nut 108 and the rotation axis of the first screw motor 105 is called the moving pair length of the first screw motor assembly. The first control signal sent by the controller 400 (refer to FIG. 37) includes the expected rotational speed of the first screw motor 105.

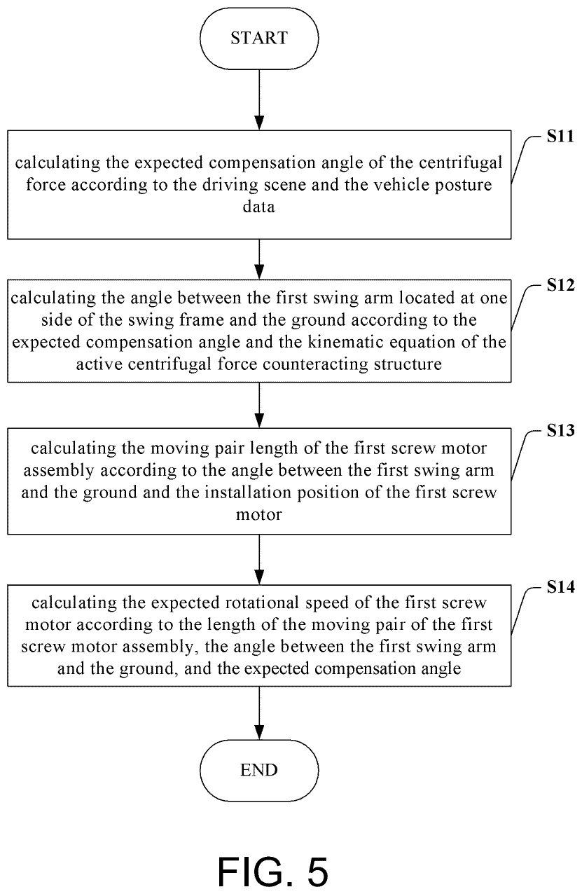

FIG. 5 is a flow chart of an embodiment of a controller calculating the expected rotational speed of the first screw motor. As shown in FIG. 5, calculating the expected rotational speed of the first screw motor includes:

Step S11: calculating the expected compensation angle of the centrifugal force according to the driving scene and the vehicle posture data.

Optionally, the vehicle posture data includes but is not limited to vehicle angular velocity, vehicle angular acceleration, steering wheel angle, longitudinal vehicle speed, brake pedal signal and corrected longitudinal acceleration.

Optionally, the expected compensation angle α is calculated by the following formula:

$$α = {S}_{i} * ( {k}_{1} * δ + {k}_{2} * \dot{δ} + {k}_{3} * β )$$

Wherein, Si is the scene compensation coefficient, δ is the vehicle angular velocity, δ is the vehicle angular acceleration, β is the steering wheel angle, k1, k2, k3 are the first coefficient, the second coefficient and the third coefficient respectively. For driving scenes with large centrifugal force, the scene compensation coefficient Si is larger. For example, the scene compensation coefficient of a sharp turn is larger than the scene compensation coefficient of a high-speed lane change. In addition, it is expected that the compensation angle is proportional to the vehicle angular velocity, the vehicle angular acceleration and the steering wheel angle.

Step S12: calculating the angle between the first swing arm located at one side of the swing frame and the ground according to the expected compensation angle and the kinematic equation of the active centrifugal force counteracting structure.

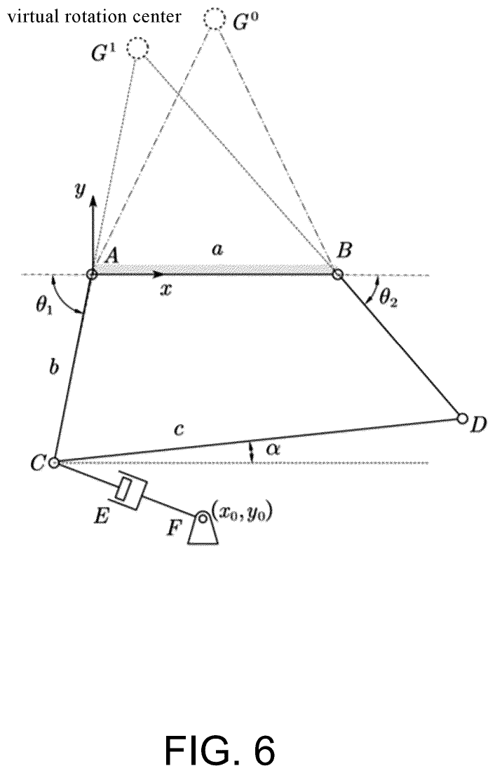

FIG. 6 is a kinematic diagram of the active centrifugal force counteracting structure. As shown in FIG. 6, from the perspective of mechanism, connecting rods AC, CD, BD and frame AB form a planar four-bar linkage. The moving pair CF and connecting rod AC form a crank moving guide rod mechanism. G° is the virtual rotation center of the static state, and G1 is the virtual rotation center of the tilting state. Wherein, connecting rod AC is also called the first swing arm, and the angle between the first swing arm and the ground is the angle θ1 between connecting rod AC and the ground Connecting rod BD is also called the second swing arm, and the angle between the second swing arm and the ground is the angle θ2 between connecting rod BD and the ground. Connecting rod CD is the swing frame, and the angle between connecting rod CD and the ground is the expected compensation angle α.

For the planar four-bar linkage, the kinematic equation is:

$$\{ \begin{matrix}b sin {θ}_{1} - b sin {θ}_{2} = c sin α \\ b cos {θ}_{1} + b cos {θ}_{2} = c cos α - a\end{matrix}$$

Wherein, the length of frame AB (i.e. the distance between adjacent first mounting seats) is a, the length of connecting rods AC and BD is b the length of connecting rod CD (i.e. the distance between adjacent pin shafts) is c, the angles between connecting rods AC and BD and the ground are θ₁ and θ₂ respectively, and the angle between connecting rod CD and the ground is a.

The angle θ₁ between the connecting rod AC and the ground can be calculated by the elimination method:

$${θ}_{1} = arctan ( \frac{{k}_{1} {k}_{2} \pm \sqrt{{k}_{1}^{2} {k}_{2}^{2} - ( {k}_{3} - {k}_{1}^{2} ) ( {k}_{3} - {k}_{2}^{2} )}}{( {k}_{3} - {k}_{1}^{2} )} )$$

in:

$${k}_{1} = c sin α , {k}_{2} = c cos α - a , {k}_{3} = \frac{{( {k}_{1}^{2} + {k}_{2}^{2} )}^{2}}{4 {b}^{2}} .$$

Wherein, a is the distance between adjacent first mounting seats, b is the length of multiple swing arms, c is the distance between adjacent pin shafts, a is the expected compensation angle, wherein, multiple swing arms, the upper side of the support seat and the swing frame constitute a four-bar linkage of an active centrifugal force counteracting structure.

Step S13: calculating the moving pair length of the first screw motor assembly according to the angle between the first swing arm and the ground and the installation position of the first screw motor.

For the crank movable guide rod mechanism, the length l_{CF} of the moving pair CF can be calculated by the following formula:

$${l}_{CF} = \sqrt{{( b sin {θ}_{1} + {x}_{0} )}^{2} + {( b cos {θ}_{1} + {y}_{0} )}^{2}}$$

Wherein, x₀ and y₀ are the horizontal and vertical coordinates of the fixed end of the screw rod in the coordinate system with point A as the origin.

Step S14: calculating the expected rotational speed of the first screw motor according to the length of the moving pair of the first screw motor assembly, the angle between the first swing arm and the ground, and the expected compensation angle.

1) Differentiate the length of the moving pair of the first screw motor assembly, the angle between the first swing arm and the ground, and the expected compensation angle by chain derivation rule to calculate the expected motion speed of the moving pair. Optionally, the expected motion speed l_{CF} of the moving pair is calculated by the following formula:

$${i}_{CF} = \frac{{dl}_{CF}}{dt} = \frac{{dl}_{CF}}{d {θ}_{1}} \frac{d {θ}_{1}}{d α} \frac{d α}{dt}$$

Wherein: d(·) represents the differential operator, a is the expected compensation angle, θ1 is the angle between the first swing arm and the ground, and l_{CF} is the moving pair length of the first screw motor assembly.

2) Calculate the expected rotational speed of the first lead screw motor according to the expected movement speed of the moving pair and the screw lead.

Optionally, the expected rotational speed n_{d1} of the first screw motor is calculated by the following formula:

$${n}_{d 1} = \frac{2 π {i}_{CF}}{D}$$

Wherein, l_{CF} is the expected movement speed of the moving pair, in m/s; D is the screw lead, in m; n_{d1} is the expected speed of the first screw motor, in rad/s.

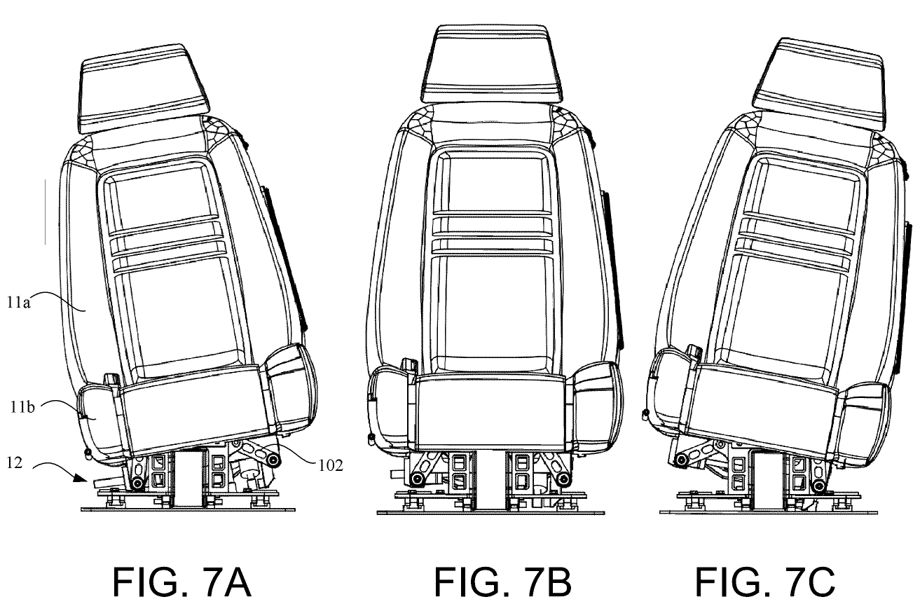

FIGS. 7A to 7C are schematic diagrams of a vehicle seat when the active centrifugal force counteracting structure is in different states.

In one embodiment, as shown in FIG. 3, the intersection of the direction extension lines of the two rolling swing arms 102 is the swing center of the swing frame 101, and the height of the swing center is equal to the height of the center of gravity of the passenger sitting on the vehicle seat 100 (refer to FIG. 1). Since the height of the swing center is equal to the height of the center of gravity of the passenger sitting on the vehicle seat 100, the arc of the human body swinging with the swing frame 101 is greatly reduced, so that although the seat 10 rotates, the displacement of the corresponding center of gravity of the human body is very small as 0˜15 mm. And since the load arm from the center of gravity to the swing center is shortened, the driving torque can be relatively reduced, so the thrust of the screw motor required to be provided is greatly reduced, reducing the consumption of the vehicle power supply.

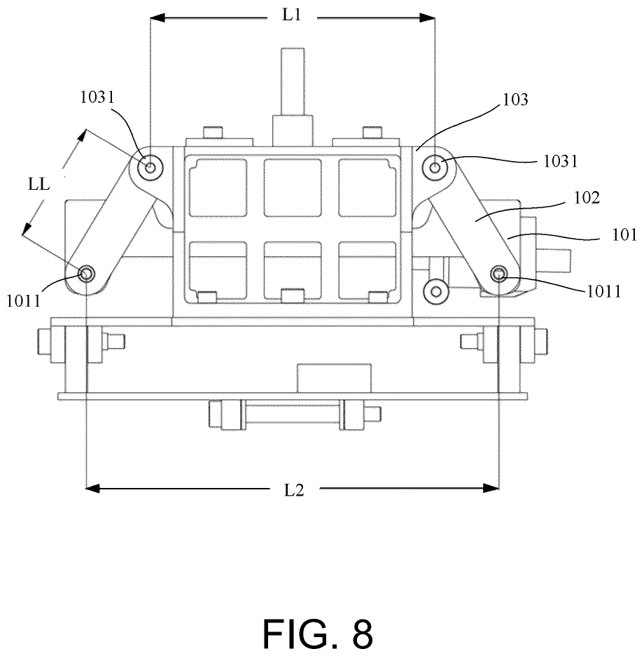

In order to make the seat more comfortable, the size relationship of the active centrifugal force counteracting structure can be further designed. Referring to FIG. 8, in one embodiment, the distance L1 between two adjacent first mounting seats 1031 connected to the rolling swing arm 102 of each support seat 103 is 170 mm to 200 mm. The distance L2 between two adjacent pin shafts 1011 connected to the rolling swing arm 102 of the swing frame 101 is 270 mm to 290 mm. At this time, when the swing frame 101 rolls, the horizontal displacement between the virtual rotation center and the center of gravity of the human body is less than 1 mm. For example, when the distance between adjacent first mounting seats 1031 is 200 mm, the distance between adjacent pin shafts 1011 is 290 mm, and the length of the rolling swing arm 102 is 87 mm, when the swing angle of the swing frame 101 to the horizontal plane is 8.6 degrees, the horizontal displacement between the rotation center and the center of gravity of the human body is about 0.15 mm. In other words, the active centrifugal force counteracting structure of the present disclosure forms an axial area with a relative horizontal displacement close to zero during the swing of the four-bar linkage. This area is also the center of gravity of an adult sitting posture. Compared with the structure with the motor placed downward, the horizontal displacement is reduced by about 70 times, so the comfort of anti-sway is better.

The robot used in the vehicle of this embodiment can realize the recognition of various complex road conditions and driving behaviors, and drive the active centrifugal force counteracting structure to compensate for the centrifugal force movement of the seat according to the recognition results, and calculate the expected speed of the motor according to the expected compensation angle and the expected angular velocity. The seat movement process is smooth and silky, reducing the sense of frustration and improving the riding comfort. In addition, the active centrifugal force counteracting structure includes multiple swing arms, and the intersection of the extended lines of the swing arms is the virtual rotation center of the active centrifugal force counteracting structure. The height of the virtual rotation center is greater than or equal to the center of gravity of the human body sitting on the seat. The arc of the human body swinging with the swing frame is greatly reduced, so that although the seat rotates, the displacement of the corresponding center of gravity of the human body is very small. In addition, since the load arm from the center of gravity to the virtual rotation center is shortened, the driving torque can be relatively reduced, so the thrust of the push rod motor required to be provided is greatly reduced, reducing the consumption of the vehicle power supply.

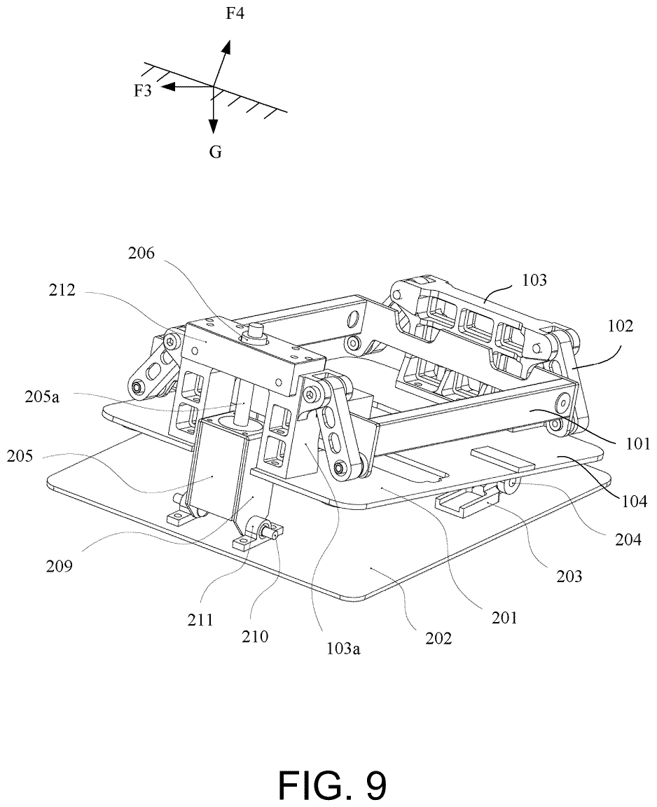

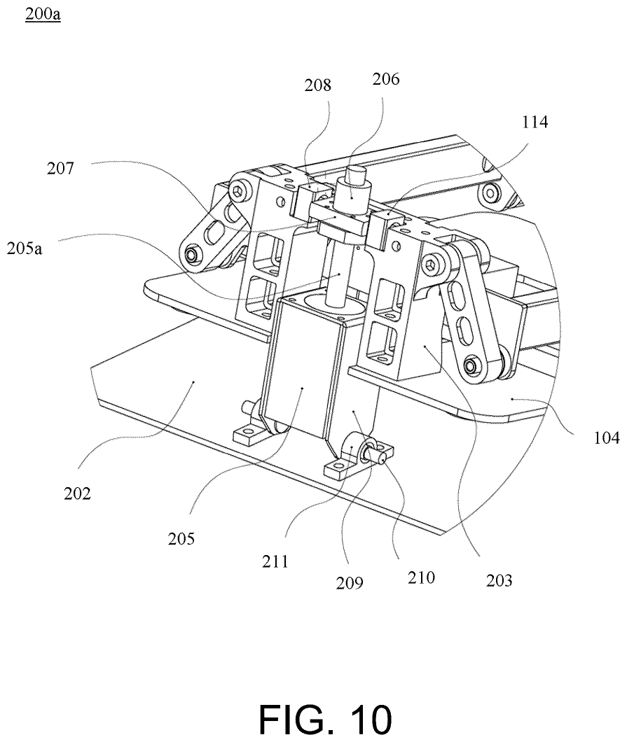

FIG. 9 is a schematic diagram of a robot structure with an inertia force counteracting structure according to an embodiment of the present disclosure. FIG. 10 is an enlarged schematic diagram of the inertia force counteracting structure in FIG. 9. As shown in FIGS. 9-10, the inertia force counteracting structure 200a includes a second base plate 202, a pitch rotation shaft seat 203, a pitch rotation shaft 204, and a second screw motor assembly. The second screw motor assembly includes a second screw motor 205, a second screw nut 206, a nut rotating plate 207, and a rotating plate shaft seat 208.

The first base plate 104 and the second base plate 202 of the active centrifugal force counteracting mechanism 100 are rotatably connected through the pitching shaft seat 203 and the pitching shaft 204, the fixed end of the second screw motor assembly is connected to the second base plate 202, the movable end of the second screw motor assembly is connected to the first support seat 103a of the active centrifugal force counteracting structure 100, and the first support seat 103a is fixedly connected to the first base plate 104. In this embodiment, the second screw motor 205 is rotatably connected to the second screw nut 206, and the second screw nut 206 is installed on the rotating plate shaft seat 208 through the nut rotating plate 207. The rotating plate shaft seat 208 is installed on the first support seat 103a. When the second screw motor 205 rotates, the second screw 205a rotates and then performs linear motion relative to the second screw nut 206, driving the active centrifugal force counteracting structure 100 and the seat surface 11a to perform pitch motion to absorb the inertial force during impact.

The controller 400 obtains the speed and acceleration of the vehicle. When the speed is close to 0 but the acceleration is greater than the preset acceleration, the vehicle makes emergency braking or is impacted. The controller 400 controls the second screw 205a of the second screw motor 205 to rotate and then make a linear motion relative to the second screw nut 206, thereby driving the first base plate 104 to perform a pitching motion to absorb the inertial force during the impact. For example, when the screw length between the second screw motor 205 and the second screw nut 206 increases, the second screw nut 206 drives the first base plate 104 to “tilt its head up”. At this time, the force analysis is as follows: the passenger is subjected to the forward inertial force F3, the gravity G and the support force F4 of the seat surface. The combined force of the gravity G and the support force F4 of the seat surface is opposite to the direction of the inertial force F3. The second screw motor 205 drives the first base plate 104 to perform a pitching motion to absorb the inertial force during the impact.

In one embodiment, the second screw motor assembly further includes a second motor bracket 209, a motor swing shaft 210 and a swing shaft seat 211. The second screw motor 203 is disposed on the second motor bracket 209, and the second motor bracket 209 is fixed to the second base plate 202 through the motor swing shaft 210 and the swing shaft seat 211.

Optionally, the second screw motor assembly further includes a fixing plate 212. The fixing plate 212 is connected to the first support seat 103a, and a through hole is provided on the upper surface of the fixing plate 212 to allow the screw 205a of the second screw motor 205 to pass through.

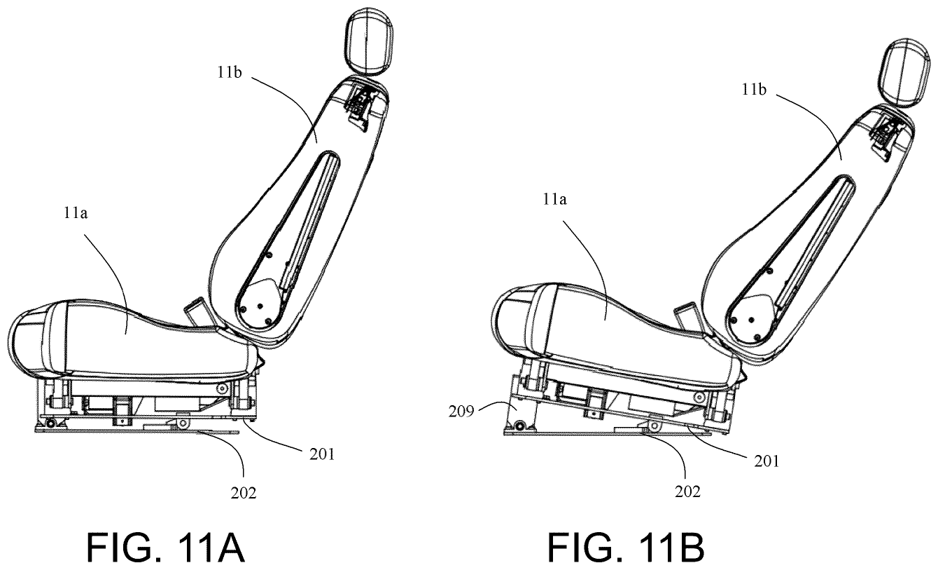

FIG. 11A-FIG. 11B are schematic diagrams of the vehicle seat when the inertial force counteracting structure is in a stationary state and a head-up state, respectively. According to FIG. 10 and FIG. 11A-11B, when the screw length between the second screw nut 206 and the second screw motor 205 increases, the seat surface 11a rotates counterclockwise, thereby switching to the head-up state.

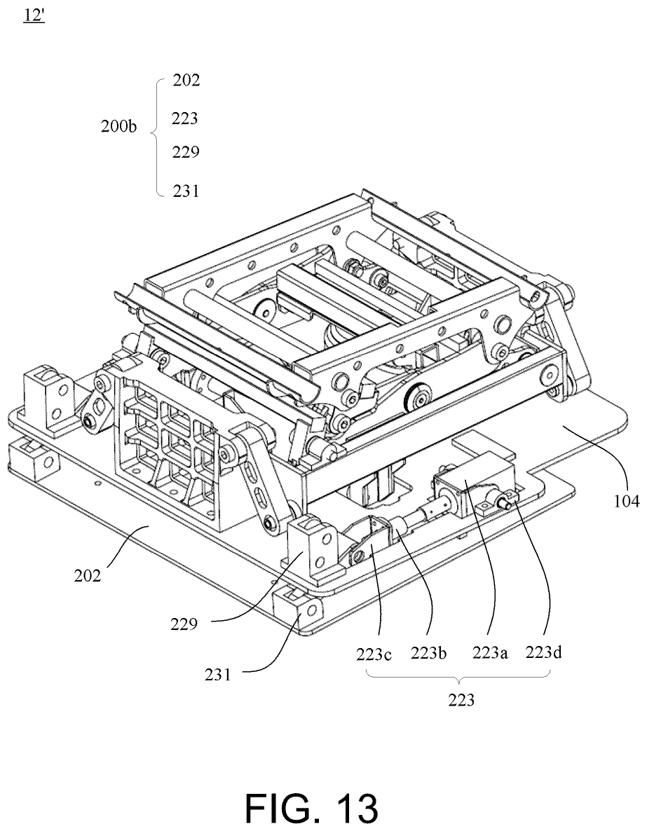

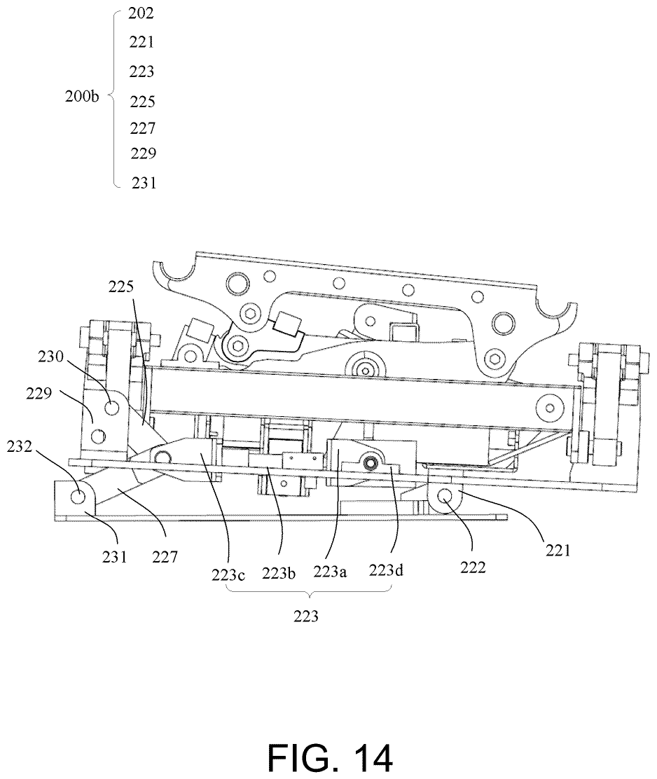

FIG. 13 is a three-dimensional schematic diagram of a robot with an inertial force counteracting structure according to another embodiment of the present disclosure. FIG. 14 is a side view of a robot with an inertial force counteracting structure according to another embodiment of the present disclosure. The robot 12′ of this embodiment can provide the seat 11 with functions such as active centrifugal force compensation, inertial force compensation and/or shock absorption. The active centrifugal force counteracting structure of this embodiment can be the same as the embodiment shown in FIG. 2 and will not be expanded here.

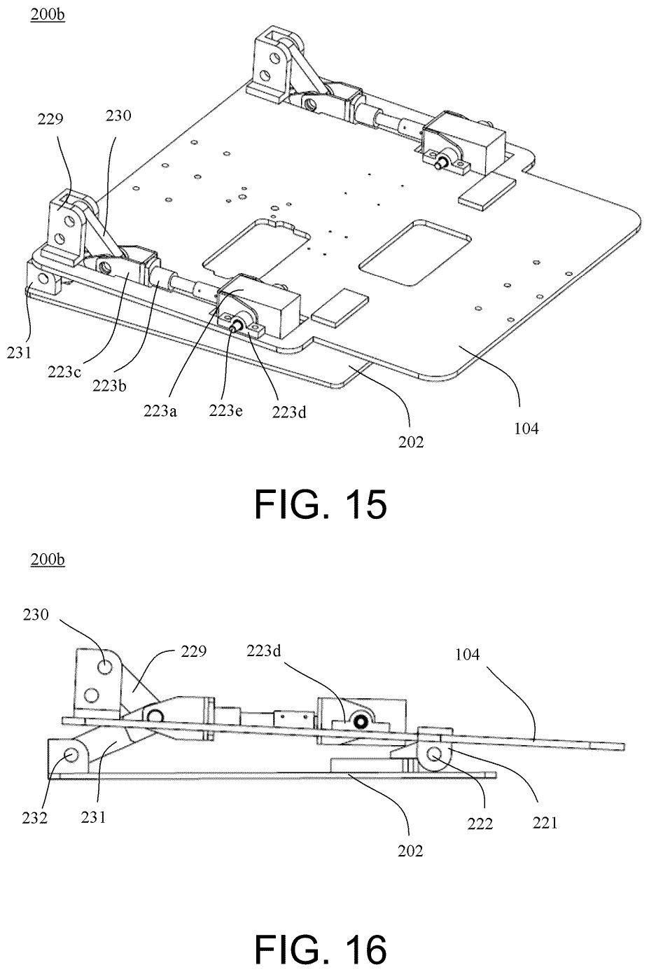

FIG. 15 is a perspective view of the inertia force counteracting structure shown in FIG. 13 of the present disclosure. FIG. 16 is a side view of the inertia force counteracting structure shown in FIG. 13 of the present disclosure. Referring to FIG. 13-16, the inertia force counteracting structure 200b includes a second base plate 202, a base plate shaft seat 221, a third screw motor assembly 223, a first pitch swing arm 225, a second pitch swing arm 227, a first swing arm shaft seat 229, and a second swing arm shaft seat 231. The second base plate 202 and the first base plate 104 are rotatably connected through the base plate shaft seat 221, and the shaft 222 is provided in the base plate shaft seat 221. The screw motor assembly 223 is provided on the first base plate 104. The first swing arm shaft seat 229 is arranged on the first bottom plate 104, and the second swing arm shaft seat 231 is arranged on the second bottom plate 202, and the two are basically opposite to each other up and down. The first swing arm shaft seat 229 is provided with a first swing arm shaft 230. The second swing arm shaft seat 231 is provided with a second swing arm shaft 232. The first pitch swing arm 225 is connected between the screw motor assembly 223 and the first swing arm shaft seat 229. The second pitch swing arm 227 is connected between the screw motor assembly 223 and the second swing arm shaft seat 231.

The first bottom plate 104 is provided with a through opening for the second pitch swing arm 227 to pass through and reach the second swing arm shaft seat 231 on the second bottom plate 202.

Further, the third screw motor assembly 223 includes a third screw motor 223a, a third screw nut 223b, a screw nut mounting seat 223c and a motor swing seat 223d. The third screw motor 223a is arranged on the first bottom plate 104 through the motor swing seat 223d. The motor swing seat 223d is provided with a motor swing shaft 223e, which passes through the housing of the third screw motor 223a, so that the third screw motor 223a swings around the swing shaft 223e.

The third screw motor 223a is rotatably connected to the third screw nut 223b. The third screw nut 223b is disposed on the screw nut mounting seat 223c, and the first pitch swing arm 225 and the second pitch swing arm 227 are rotatably connected to the screw nut mounting seat 223c. The third screw motor 223a is used to drive the third screw nut 223b to perform linear motion along the extension direction of the first base plate 104 according to the third control signal, driving the angle between the first pitch swing arm 225 and the second pitch swing arm 227 to open or close, thereby driving the active centrifugal force counteracting structure 100 to perform pitch motion.

In one embodiment, inertial force counteracting structures 200b are provided on both sides of the first base plate 104, so that the pitch motion of the first base plate 104 is more stable.

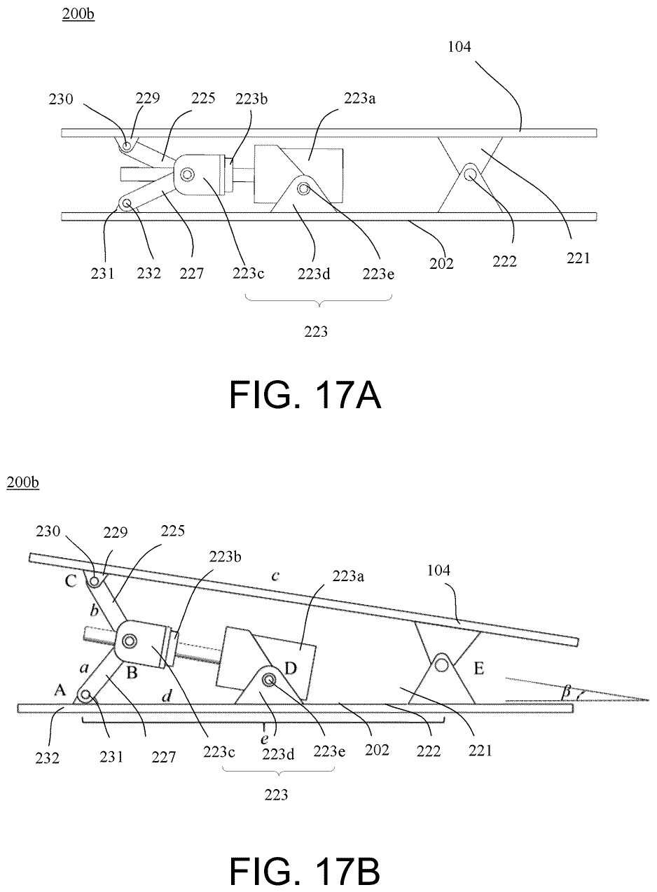

FIG. 17A and FIG. 17B are side views of an inertial force counteracting structure of another embodiment of the present disclosure. Referring to FIG. 17A-17B, the main difference between this embodiment and the embodiment shown in FIG. 13-16 is that the third screw motor assembly 223 is arranged on the second base plate 202. Other details of this embodiment can be referred to the previous embodiment and will not be expanded here.

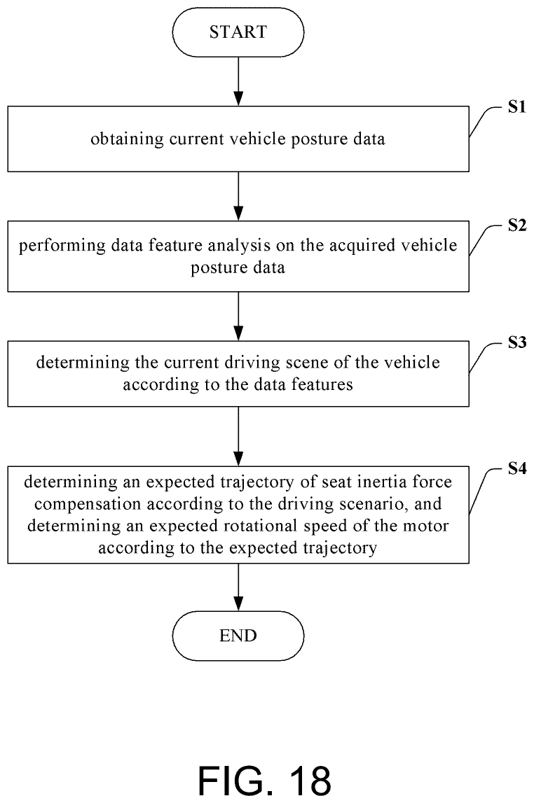

FIG. 18 is a flow chart of a control algorithm of a controller according to an embodiment of the present disclosure. As shown in FIG. 18, the control algorithm of the controller includes:

Step S1: obtaining current vehicle posture data;

In one example, the vehicle posture data includes, but is not limited to, longitudinal vehicle speed, steering wheel angle, brake pedal signal, and corrected longitudinal acceleration.

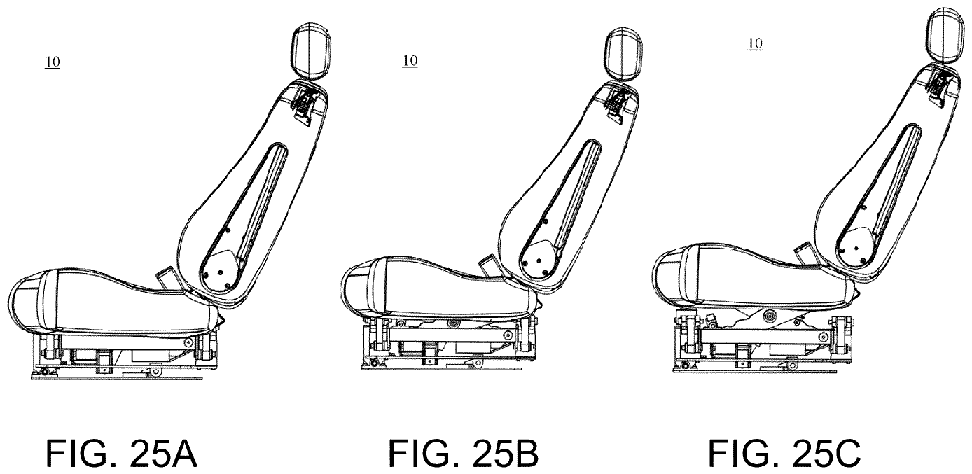

As shown in FIGS. 25A-25C, in one example, the controller 400 obtaining the current vehicle posture data includes: the controller obtaining the longitudinal vehicle speed, steering wheel angle and brake pedal signal from the on-board automatic diagnostic system (OBD) 500; the controller obtaining the longitudinal acceleration from the on-board IMU sensor 600; and the corrected longitudinal acceleration is calculated according to the longitudinal vehicle speed and the longitudinal acceleration.

In one embodiment, the corrected longitudinal acceleration is calculated by the following formula:

$${a}_{t} ( k ) = h {a}_{y} ( k ) + ( 1 - h ) \frac{{v}_{y} ( k ) - {v}_{y} ( k - 1 )}{Δ t}$$

Wherein, aₜ(k) is the corrected longitudinal acceleration, a_{y}(k) is the longitudinal acceleration obtained from the on-board IMU sensor 600, v_{y}(k) is the longitudinal vehicle speed at the current moment obtained from the OBD 500, v_{y}(k−1) is the longitudinal vehicle speed at the previous moment, Δt is the sampling interval, h is the complementary filter coefficient and takes a value between 0 and 1.

The reason for correcting the longitudinal acceleration is that the longitudinal vehicle speed signal obtained by OBD 500 can be used to obtain the longitudinal acceleration of the vehicle after differentiation, but this method will have problems such as noise amplification and sensitivity to initial parameters; in addition, the longitudinal acceleration signal directly obtained by using the on-board IMU sensor 600 will also have problems such as high-frequency noise and sensitivity to temperature; therefore, this disclosure adopts a complementary filter, which takes into account the advantages of both measurements and avoids dependence on a single sensor. In other words, the size of the complementary filter coefficient h determines whether the complementary filter trusts the result of OBD 500 differentiation more or the result of the on-board IMU sensor 600 more. The algorithm will monitor the two signals during operation and then adjust them in real time h to obtain the best at(k) estimate.

Step S2: performing data feature analysis on the acquired vehicle posture data.

For example, the peak size of the vehicle posture data signal, the duration of the peak, the signal trend and the warping, etc.

Step S3: determining the current driving scene of the vehicle according to the data features.

In one example, determining the driving scene of the vehicle according to vehicle posture data includes: when the longitudinal vehicle speed is less than or equal to a first threshold and the steering wheel angle is greater than a second threshold, determining the vehicle's driving scene is a sharp turn; when the longitudinal vehicle speed is greater than the first threshold and the steering wheel angle is less than a fifth threshold, determining the vehicle's driving scene is a high-speed lane change; when a brake pedal signal exists and the corrected longitudinal acceleration is greater than a third threshold, determining the vehicle's driving scene as an emergency braking; when the brake pedal signal does not exist and the corrected longitudinal acceleration is greater than a fourth threshold, determining the vehicle's driving scene is an emergency acceleration.

Step S4: determining an expected trajectory of seat inertia force compensation according to the driving scenario, and determining an expected rotational speed of the motor according to the expected trajectory.

The movement style of the seat inertia force counteracting structure and the active centrifugal force counteracting structure is determined according to the driving scene status, and then the inertia force is compensated in real time. The inertia force here includes the inertia force of the human body during braking and the centrifugal force exerted on the human body during sharp turns.

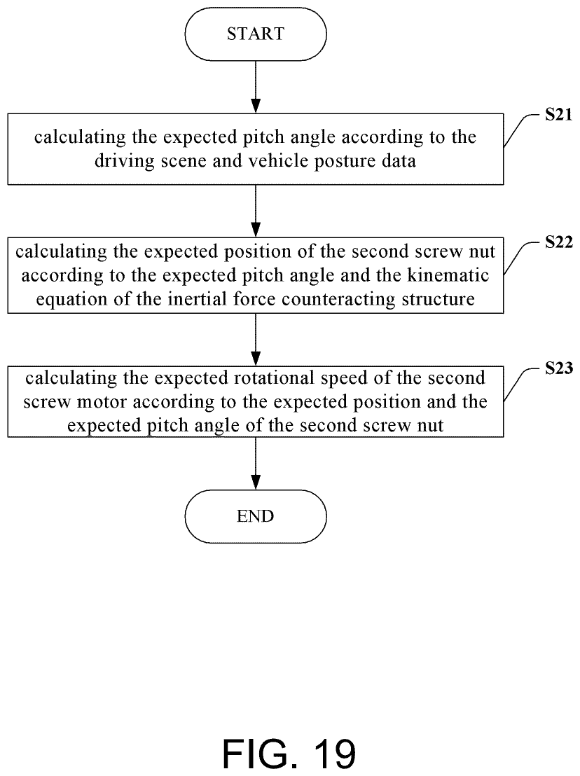

Taking the control algorithm of the seat inertia force counteracting structure during braking as an example, when the driving scene is emergency braking or emergency acceleration, a second control signal is issued. The second control signal includes the expected speed of the second screw motor. The controller is also configured to calculate the expected speed of the second screw motor. FIG. 19 is a flow chart of the controller of one embodiment of the present disclosure calculating the expected speed of the second screw motor. As shown in FIG. 19, calculating the expected speed of the second screw motor includes:

Step S21: calculating the expected pitch angle according to the driving scene and vehicle posture data.

For example, the expected compensation angle β is calculated by the following formula:

$$β = {S}_{i} * ( {k}_{4} * {a}_{t} ( k ) )$$

Wherein, Si is the scene compensation coefficient, k4 is the fourth coefficient, and at(k) is the corrected longitudinal acceleration.

For driving scenes with greater impact force, the scene compensation coefficient Si is larger. For example, the scene compensation coefficient of emergency braking is greater than the scene compensation coefficient of slow braking. In addition, the expected pitch angle is proportional to the corrected longitudinal acceleration.

Step S22: calculating the expected position of the second screw nut according to the expected pitch angle and the kinematic equation of the inertial force counteracting structure.

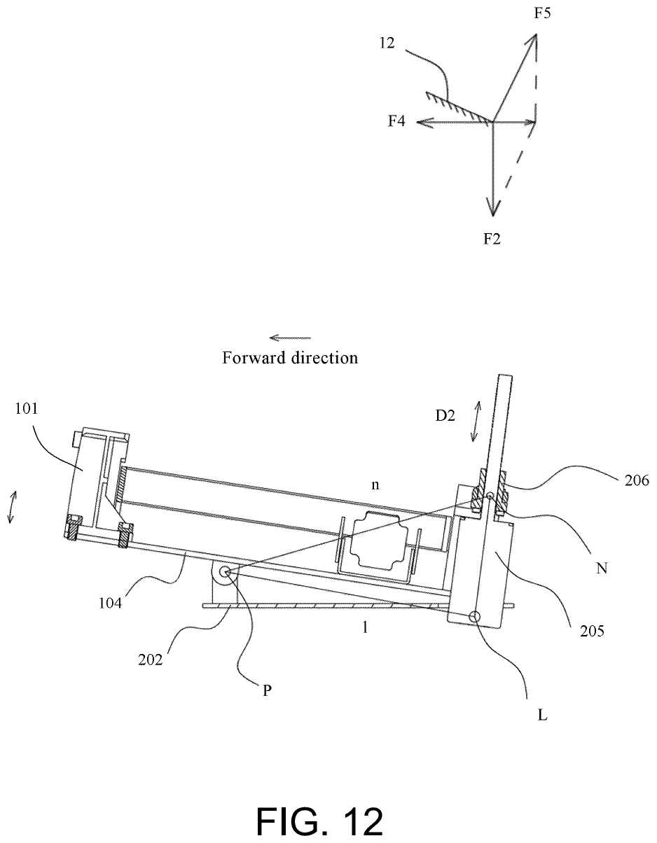

As shown in FIG. 12, the position of the pitch axis is the pitch rotation center P, the second screw motor rotation axis L, and the second screw nut rotation center N. It can be seen that the seat is installed on the first base plate 104, and controlling the pitch movement of the seat is to control the movement angle of the first base plate 104, and the movement angle of the first base plate 104 is determined by the length of the moving pair LN.

Optionally, the expected position of the second screw nut is calculated by the following formula:

$${l}_{LN} = \sqrt{{l}^{2} + {n}^{2} - 2 nl cos β}$$

Wherein, I_{LN} is the length from the second screw nut rotation center N to the second screw motor rotation axis L, l is the length from the second screw motor rotation axis L to the pitch rotation center Pn, n is the length from the pitch rotation center P to the second screw nut rotation center N, and β is the expected pitch angle.

Step S23: calculating the expected rotational speed of the second screw motor according to the expected position and the expected pitch angle of the second screw nut.

The motion speed of the moving pair LN can be further calculated by the chain derivation rule, namely:

$${\dot{l}}_{LN} = \frac{{dl}_{LN}}{dt} = \frac{{dl}_{LN}}{d β} \frac{d β}{dt}$$

Wherein: d(·) represents the differential operator.

In this example, the motor-screw transmission mode is used as the driving mode of the moving pair LN, and the expected speed of the motor is calculated as follows:

$${n}_{d 2} = \frac{2 π {\dot{l}}_{LN}}{D}$$

Wherein: D is the screw lead, in m; n_{d2} is the expected speed of the second screw motor, in rad/s.

The robot used in a vehicle of this embodiment can realize that when emergency braking occurs, the inertia force counteracting structure 200a is driven to lift the active centrifugal force counteracting structure 100 and the seat surface 11a to offset the inertia force in the forward direction of the vehicle, so that passengers will not easily leave the seat surface 11a, thereby improving riding comfort and safety.

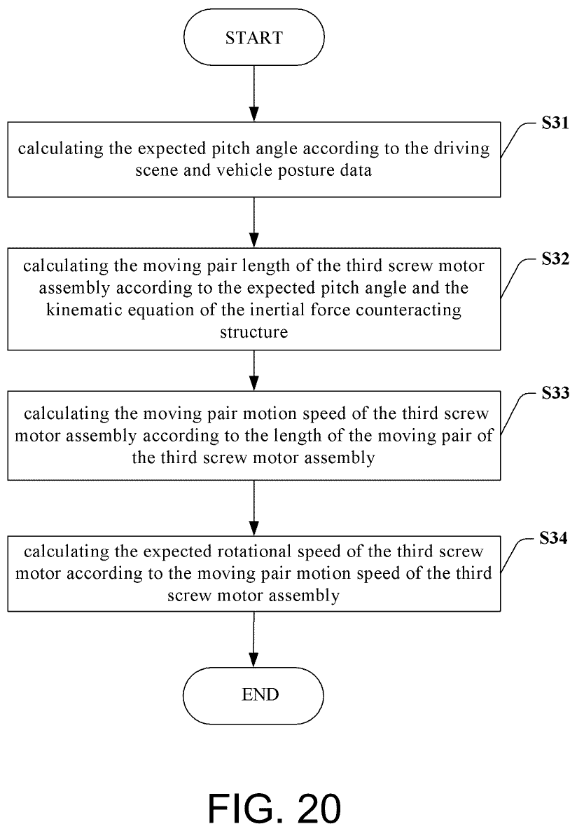

FIG. 20 is a flow chart of a controller calculating the expected rotational speed of the third screw motor according to an embodiment of the present disclosure. As shown in FIG. 20, calculating the expected rotational speed of the third screw motor includes:

Step S31: calculating the expected pitch angle according to the driving scene and vehicle posture data.

For example, the expected compensation angle β is calculated by the following formula:

$$β = {S}_{i} * ( {k}_{4} * {a}_{t} ( k ) )$$

Wherein, Si is the scene compensation coefficient, k4 is the fourth coefficient, and at(k) is the corrected longitudinal acceleration.

For driving scenes with greater impact force, the scene compensation coefficient Si is larger. For example, the scene compensation coefficient of emergency braking is greater than the scene compensation coefficient of slow braking. In addition, the expected pitch angle is proportional to the corrected longitudinal acceleration.

Step S32: calculating the moving pair length of the third screw motor assembly according to the expected pitch angle and the kinematic equation of the inertial force counteracting structure.

For the swing guide mechanism, when the angle between the seat plane and the horizontal plane is β, the length of the moving pair BD is:

$${l}_{BD} = \sqrt{\begin{matrix}{a}^{2} + {d}^{2} - 2 ad cos ( arccos \frac{e - c cos β}{\sqrt{{c}^{2} + {e}^{2} - 2 ce cos β}} - \\ arccos \frac{{c}^{2} + {e}^{2} + {a}^{2} - {b}^{2} - 2 ce cos β}{2 a \sqrt{{c}^{2} + {e}^{2} - 2 ce cos β}} )\end{matrix}}$$

a is the length AB of the second pitch swing arm, b is the length BC of the first pitch swing arm, c is the distance CE from the first swing arm shaft seat on the first base plate to the bottom plate rotating shaft seat, d is the distance AD from the second swing arm shaft seat on the second base plate to the motor swing shaft seat, e is the distance AE from the second swing arm shaft seat on the second base plate to the bottom plate rotating shaft seat, and β is the expected pitch angle. Here, the distance of each shaft seat is calculated with the rotating shaft as its center position.

Step S33: calculating the moving pair motion speed of the third screw motor assembly according to the length of the moving pair of the third screw motor assembly.

The motion speed of the moving pair BD can be further calculated by the chain derivation rule, that is:

$${\dot{l}}_{BD} = \frac{{dl}_{BD}}{dt} = \frac{{dl}_{BD}}{d β} \frac{d β}{dt}$$

Wherein: d(·) represents the differential operator.

Step 34, calculating the expected rotational speed of the third screw motor according to the moving pair motion speed of the third screw motor assembly.

In this example, the motor-screw transmission mode is used as the driving mode of the moving pair BD, and the expected speed of the motor is calculated as follows:

$${n}_{d 3} = \frac{2 π {\dot{l}}_{BD}}{D}$$

Wherein: D is the screw lead, in m; n_{d3} is the expected rotational speed of the third screw motor, in rad/s.

The robot used in a vehicle of this embodiment can realize that when emergency braking occurs, the inertia force counteracting structure 200a is driven to lift the active centrifugal force counteracting structure 100 and the seat surface 11a to offset the inertia force in the forward direction of the vehicle, so that passengers will not easily leave the seat surface 11a, thereby improving riding comfort and safety.

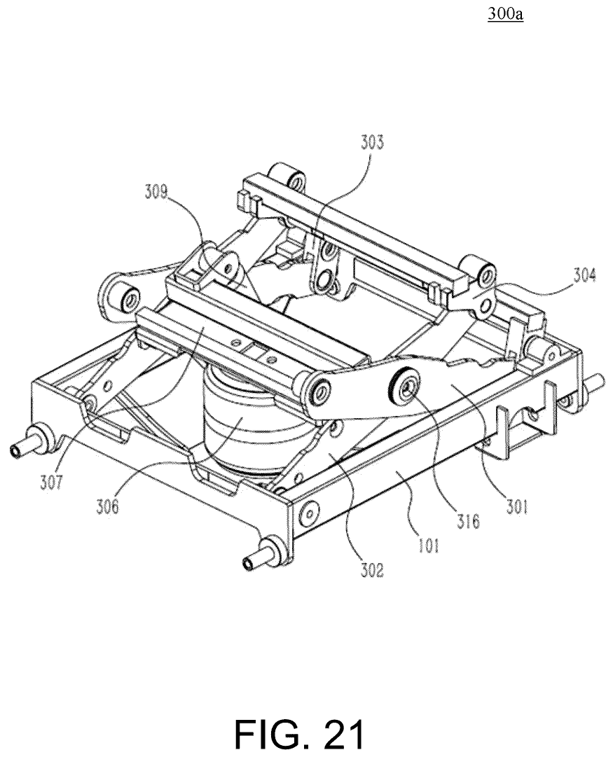

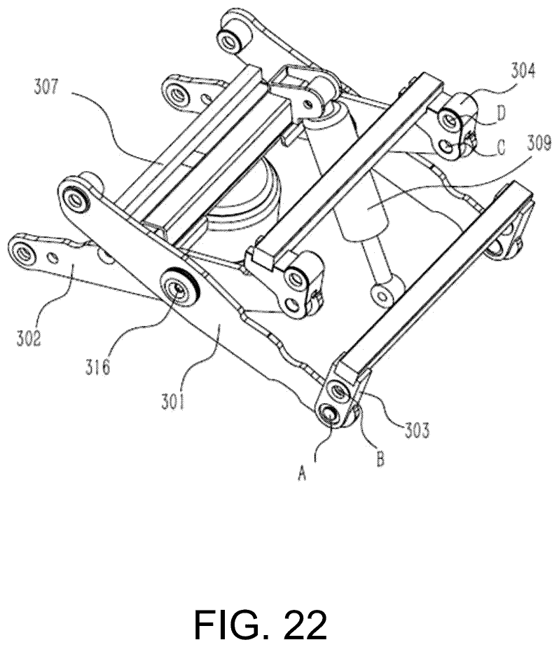

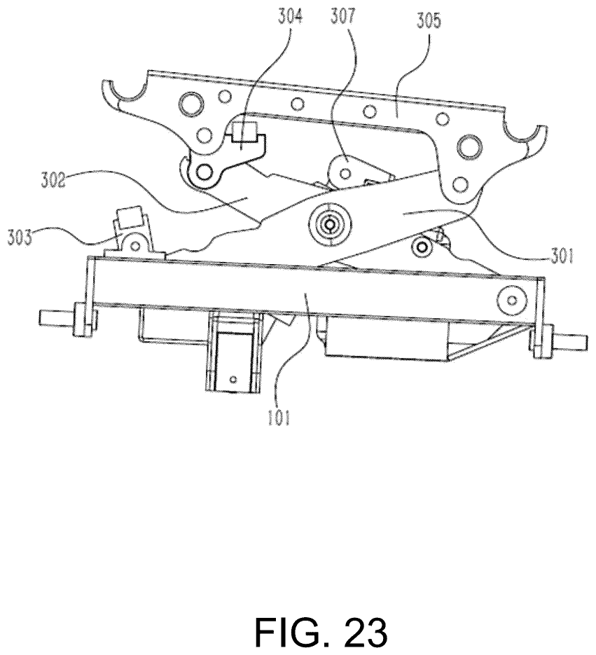

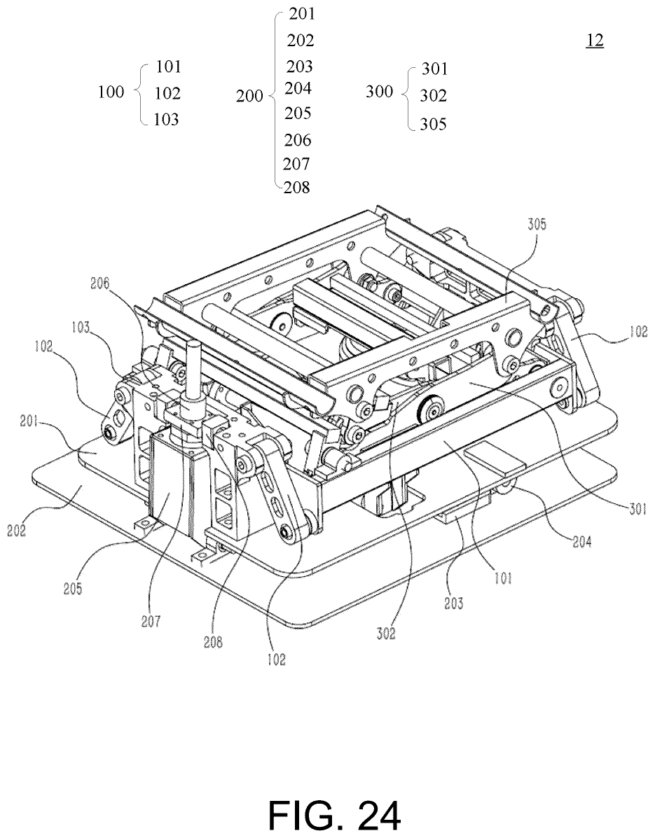

FIGS. 21-23 are schematic diagrams of the structure of the semi-active shock absorbing structure of an embodiment of the present disclosure from different perspectives. FIGS. 25A-25C is a schematic diagram of the structure of a robot with a semi-active shock absorbing structure of an embodiment of the present disclosure. As shown in FIGS. 21-23 and 24, the semi-active shock absorbing structure 300a of the present embodiment includes an outer cross arm 301 and an inner cross arm 302, a lower swing arm 303, an upper swing arm 304 and a seat mounting bracket 305. The outer cross arm 301 is connected to the inner cross arm 302 through a cross arm rotating shaft 316, the lower swing arm 303 includes a first rotation pair A and a second rotation pair B, and the upper swing arm 304 includes a third rotation pair C and a fourth rotation pair D.

The lower end of the inner cross arm 302 is connected to the swing frame 101, the lower end of the outer cross arm 301 is connected to the first rotation pair A of the lower swing arm 303, and the second rotation pair B of the lower swing arm 303 is connected to the swing frame 101; the upper end of the outer cross arm 301 is connected to the seat mounting bracket 305, the upper end of the inner cross arm 302 is connected to the third rotation pair C of the upper swing arm 304, the fourth rotation pair D of the upper swing arm 304 is connected to the seat mounting bracket 305, and the seat surface 11a is installed on the seat mounting bracket 305.

When the upper plane of a conventional scissor-fork mechanism moves in the Z-axis direction (i.e., vertical direction), the horizontality of the upper plane is maintained by the roller at the end of the fork arm rolling back and forth. The disadvantage is that long-term rolling will cause wear. When the scissor-fork mechanism of this embodiment moves in the Z-axis direction perpendicular to the seat surface, it is achieved by rotating the lower swing arm 303 and the upper swing arm 304. In other words, this embodiment forms four rotating pairs at the positions of the first rotating pair A, the second rotating pair B, the third rotating pair C, and the fourth rotating pair D. The scissor-fork mechanism moves in the Z-axis direction through the four rotating pairs, which can reduce friction during movement and reduce structural wear.

As shown in FIG. 2, in one embodiment, the semi-active shock absorbing structure 300 further includes an airbag (also called an air spring) 306, an airbag top plate 307 and an airbag mounting seat 308. The airbag mounting seat 308 is connected to the inner wall of the swing frame 101. The airbag 306 is located between the airbag mounting seat 308 and the airbag top plate 307, and the airbag top plate 307 is connected to the inner wall of the outer cross arm 301. After the airbag 306 is inflated and pressurized, the pressure on the airbag 306 will change due to the up and down bumping of the passenger. When the passenger is bumped and landed, the pressure on the airbag increases, the airbag 306 is compressed, and the scissor mechanism is compressed at the same time; when the passenger is bumped and bounced up, the pressure on the airbag is reduced or removed, and the airbag 306 will be restored to its original state due to the rebound, and the scissor mechanism is stretched at the same time. By compressing and rebounding the airbag 306, the scissor mechanism simultaneously drives the seat 11a to move up and down in the Z-axis direction, thereby filtering out vibrations in the Z-axis direction.

In one embodiment, the controller 400 is further configured to control the total amount of air in the airbag 306 according to the weight of the passenger on the seat surface, so as to ensure that the passenger has a wide forward field of vision. For example, the semi-active shock absorbing structure 300 is provided with an inflation/deflation mechanism 320 (refer to FIG. 37), so that the airbag 306 can be inflated or deflated under the control of the controller 400 when necessary. The existing vehicle seats are of an integrated design, which cannot be properly adjusted according to the weight of the passenger and do not have a safe field of vision. At present, passengers can only adjust themselves by intuitive feeling, and due to limitations, they often cannot obtain a more comfortable and safe field of vision. For example, before the vehicle is started, the displacement data of the seat mounting bracket 305 in the direction perpendicular to the seat surface when the passenger sits on the seat is detected by a displacement sensor, and the displacement data reflects the weight of the passenger. The controller 400 controls the inflation amount of the airbag 306 according to the displacement data. For example, when the displacement data is higher than the displacement data corresponding to the preset standard weight of the standard displacement data, more air is added to the airbag 306; when the displacement data is lower than the standard displacement data, part of the air is released from the airbag 306. In this embodiment, the total amount of air in the airbag 306 is controlled by the controller 400, so that passengers of different weights can keep the seat surface at a suitable height and the passengers have a comfortable field of vision.

Optionally, the semi-active shock absorbing structure 300 further includes a magnetorheological damper 309, one end of which is fixed to the first bottom plate 104, and the other end is connected to the airbag top plate 307. Under the action of the magnetorheological damper 309, the rebound and compression of the scissor mechanism are softer.

FIGS. 25A-25C are schematic diagrams of a vehicle seat when the semi-active shock absorbing structure is in different states.

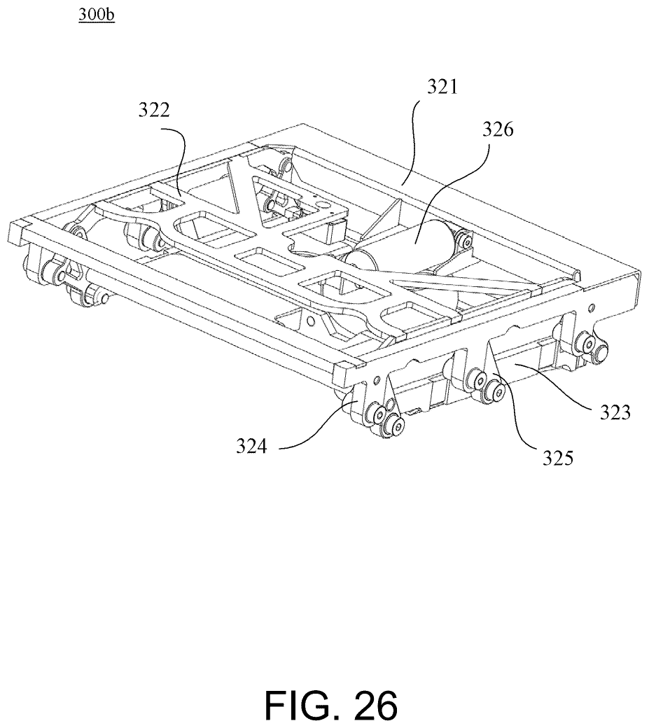

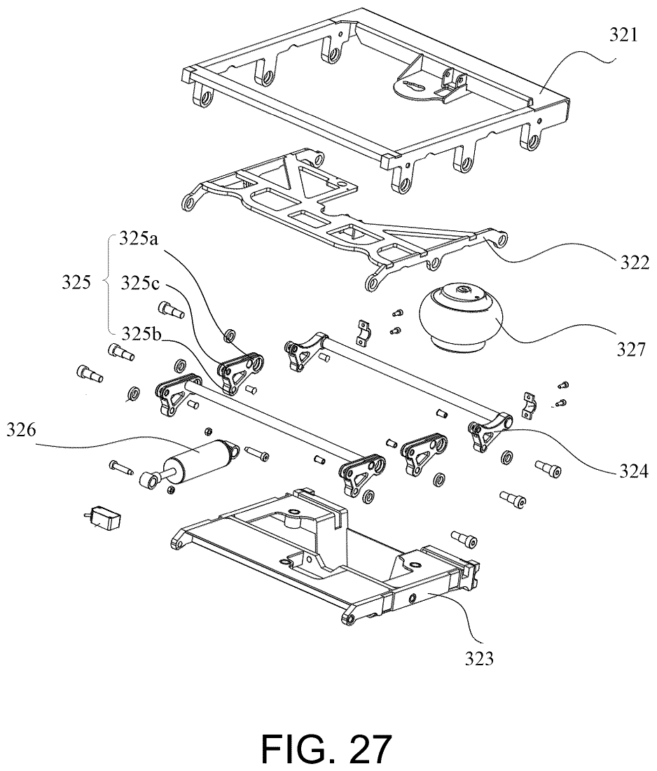

As shown in FIG. 26 and FIG. 27, some embodiments of the present disclosure disclose another semi-active shock absorbing structure 300b, which is a multi-link parallel shock absorbing mechanism, which includes an upper mounting frame 321, a secondary connecting rod frame 322, a base lower frame 323 and at least two sets of mutually parallel swing arm assemblies 324. Multiple ends of the swing arm assembly 324 are rotatably connected to the base lower frame 323, the upper mounting frame 321 and the secondary connecting rod frame 322. The multi-link parallel shock absorbing mechanism causes the swing arm assembly 324 to swing synchronously in the same direction through the secondary connecting rod frame 322, thereby realizing the vertical shock absorbing movement of the upper mounting frame 321.

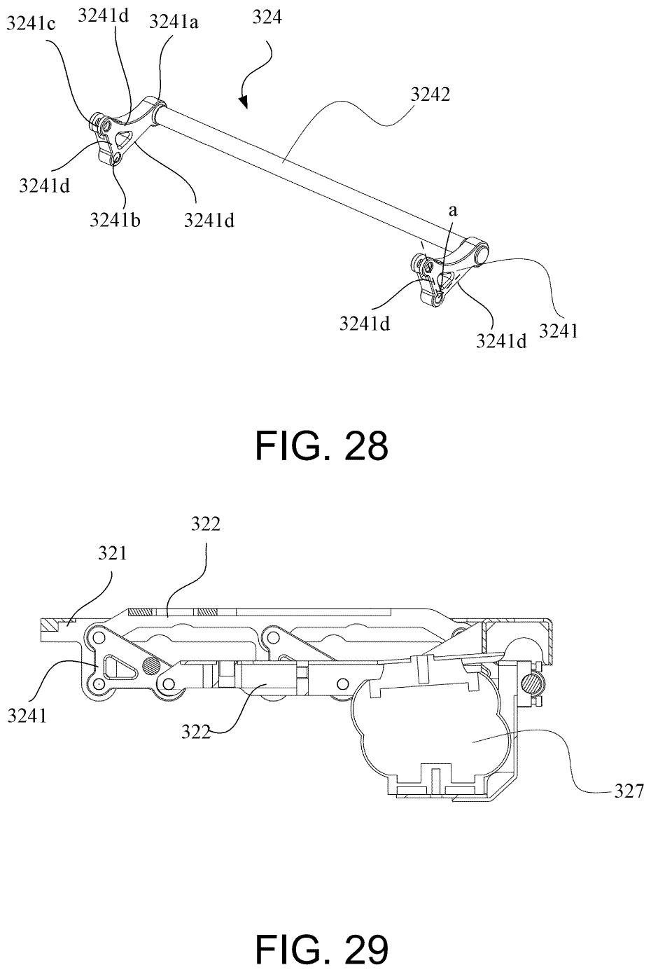

According to FIG. 27 and FIG. 28, in this embodiment, each group of swing arm assemblies 324 includes two pairs of first combined swing arms 3241 and a torsion bar 3242, and the torsion bar 3241 is installed at the end of the base lower frame 323. The first ends 3241a of the two first combined swing arms 3241 are respectively rotatably connected to the two ends of the torsion bar 3242. The second ends 3241b of the two first combined swing arms 3241 are respectively rotatably connected to the two ends of the upper mounting frame 321, and the third ends 3241c of the first combined swing arms 3241 are respectively rotatably connected to the two ends of the secondary connecting rod frame 322.

In one embodiment, the first combined swing arm 3241 is composed of a plurality of connecting rods. For example, in this embodiment, the first combined swing arm 3241 includes three connecting rods 3241d, and the connecting rods 3241d are sequentially connected to form a triangular structure.

Furthermore, the two connecting rods 3241d located at the second end 3241b of the first combined swing arm 3241 are perpendicular to each other, that is, the angle a between the two connecting rods 3241d is a right angle. This structural arrangement allows the first end 3241a and the second end 3241b to be located on the same straight line when the first combined swing arm 3241 rotates to the middle plane of the shock absorbing amplitude.

As shown in FIG. 27, the multi-link parallel shock absorbing mechanism further includes at least one pair of second combined swing arms 3243. Here, the structure of the second combined swing arm 3243 is preferably set to be the same as the structure of the first combined swing arm 3241, that is, the second combined swing arm 3243 includes three connecting rods, and the three connecting rods are sequentially connected to form a triangular structure. The first end 3243a of each pair of second combined swing arms 3243 is respectively rotatably connected to the base lower frame 323, the second end 3243b of the second combined swing arm 3243 is respectively rotatably connected to the two ends of the upper mounting frame 321, and the third end 3243c of the second combined swing arm 3243 is respectively rotatably connected to the two ends of the secondary connecting rod frame 322. The two connecting rods located at the second end 3243b of the second combined swing arm 3243 are perpendicular to each other, that is, the angle between the two connecting rods is a right angle (its structure is the same as that of the first combined swing arm 3243).

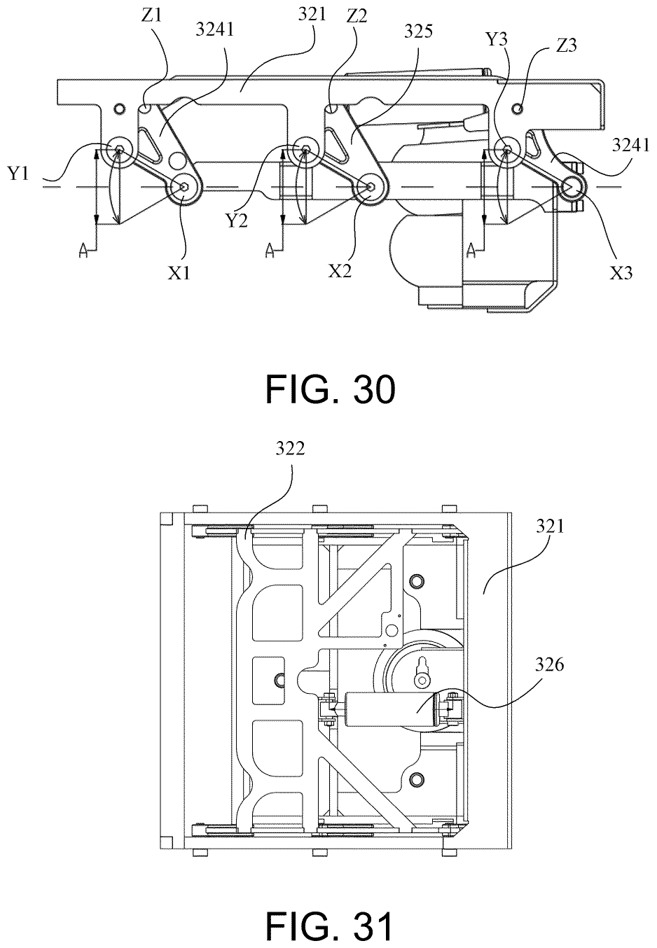

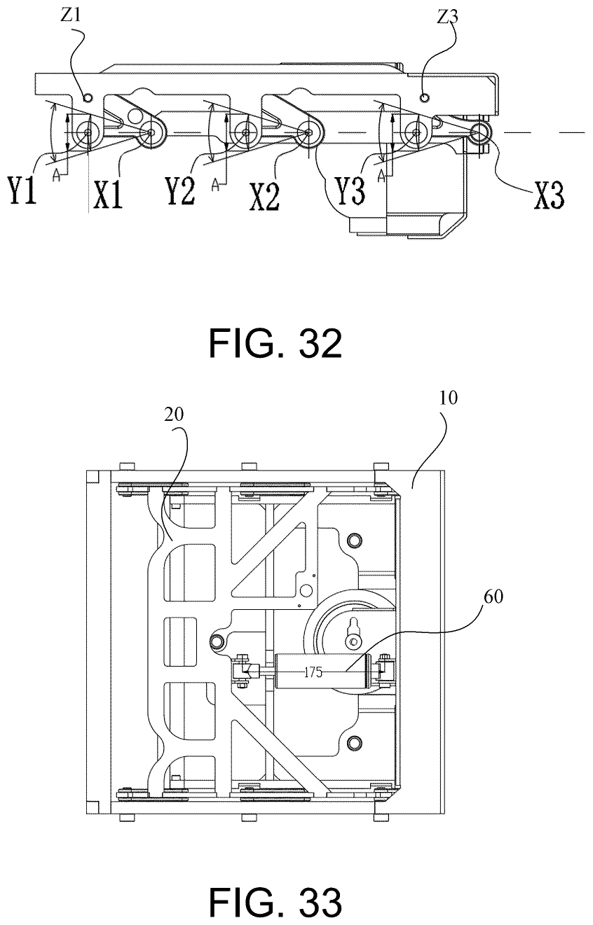

Furthermore, in this embodiment, it is preferably arranged that the first end 3241a of the first combined swing arm 3241 can be rotatably connected to the base lower frame 323 through a rotating shaft (for example, the rotating shaft X1 and the rotating shaft X3 as shown in FIGS. 30, 32 and 34), and the first end 3243a of the second combined swing arm 3243 can be rotatably connected to the base lower frame 323 through a rotating shaft (for example, the rotating shaft X2 shown in FIGS. 30, 32 and 34), and the rotating shaft X1, the rotating shaft X2 and the rotating shaft X3 are located on the same straight line.

Similarly, the second end 3241b of the first combined swing arm 3241 can be rotatably connected to the upper mounting frame 321 through a rotating shaft (for example, the rotating shaft Y1 and the rotating shaft Y3 shown in FIGS. 30, 32 and 34), and the second end 3243b of the second combined swing arm 3243 can be rotatably connected to the upper mounting frame 321 through a rotating shaft (for example, the rotating shaft Y2 shown in FIGS. 30, 32 and 34), and the rotating shaft Y1, the rotating shaft Y2 and the rotating shaft Y3 are located on the same straight line.

The third end 3241c of the first combined swing arm 3241 can be rotatably connected to the secondary connecting rod frame 322 through a rotating shaft (for example, the rotating shaft Z1 and the rotating shaft Z3 shown in FIGS. 30, 32 and 34), and the third end 3243c of the second combined swing arm 3243 can be rotatably connected to the secondary connecting rod frame 322 through a rotating shaft (for example, the rotating shaft Z2 shown in FIGS. 30, 32 and 34), and the rotating shaft Z1, the rotating shaft Z2 and the rotating shaft Z3 are located on the same straight line.

In this embodiment, the first combined swing arm 3241 and the second combined swing arm 3243 are provided with the following two important functions. First, the first combined swing arm 3241 and the second combined swing arm 3243 can be connected to each other by the torsion bar 3242, so that the first combined swing arm 3241 and the second combined swing arm 3243 on both sides can move synchronously. Second, the first combined swing arm 3241 and the second combined swing arm 3243 distribution table have three ends, which are rotatably connected with the upper mounting frame 321, the secondary connecting rod frame 322 and the base lower frame 323 through three rotating shafts, so that the upper mounting frame 321 installed on the rotating shaft Y1, the rotating shaft Y2 and the rotating shaft Y3 can move around the rotating shaft X1, the rotating shaft X2 and the rotating shaft X3 respectively. In the present disclosure, a secondary connecting rod frame 20 is provided which is connected to the rotating shaft Z1, the rotating shaft Z2 and the rotating shaft Z3 of the first combined swing arm 3241 and the second combined swing arm 3243, so as to ensure that the movement of the upper mounting frame 10 has no singularity.

As shown in FIG. 27, in one embodiment, the multi-link parallel shock absorbing mechanism further includes a magnetorheological damper 326, which is horizontally arranged and installed between the upper mounting frame 321 and the secondary link frame 322. The arrangement of the magnetorheological damper 326 can maximize the use of the magnetorheological stroke, which refers to the ability to generate algorithmically controllable motion shock absorbing force.

As shown in FIG. 29, in one embodiment, the multi-link parallel shock absorbing mechanism further includes an airbag 327, which is mounted at the bottom of the upper mounting frame 10 and directly applies thrust to the upper mounting frame 321. This structure allows the airbag 327 to be arranged and connected in an almost vertical direction of use, and can directly apply thrust to the upper mounting frame 321, so that thrust loss is minimized, and the airbag 327 can work with very small air pressure.

Similar to the previous embodiment, the controller 400 is also configured to control the total amount of air in the airbag 306 according to the weight of the passenger on the seat surface to ensure that the passenger has a wide forward field of vision and is no longer deployed.

As shown in FIG. 30 and FIG. 31, when the first combined swing arm 3241 and the second combined swing arm 3243 rotate to the highest shock-absorbing height position, the secondary connecting rod frame 322 moves vertically upward, driving the upper mounting frame 321 to move to the highest height position. At this time, the distance between the highest shock-absorbing height position and the lowest shock-absorbing height position of the swing arm assembly 40 is A (as shown in FIG. 30).

As shown in FIG. 30 and FIG. 33, when the first combined swing arm 3241 and the second combined swing arm 3243 rotate to the middle shock absorption height position, the rotating shaft Y1, the rotating shaft Y2 and the rotating shaft Y3 move to the middle plane of the shock absorption amplitude (i.e. the center line position of the base lower frame 323), and the rotating shaft Y1, the rotating shaft Y2 and the rotating shaft Y3 are on the same plane as the rotating shaft X1, the rotating shaft X2 and the rotating shaft X3. Since the secondary connecting rod frame 322 is provided here, that is, the upper part is rotatably connected to the secondary connecting rod frame 322 through the rotating shaft Z1, the rotating shaft Z2 and the rotating shaft Z3, the upper mounting frame 31 is avoided from generating an uncertain singular phenomenon (i.e., the rotating shaft Y1 and the rotating shaft Y3 have two upward or downward movement directions), so that the rotating shaft Y1, the rotating shaft Y2 and the rotating shaft Y3 have only one movement direction, and the purpose of synchronous upward or synchronous downward movement is achieved.

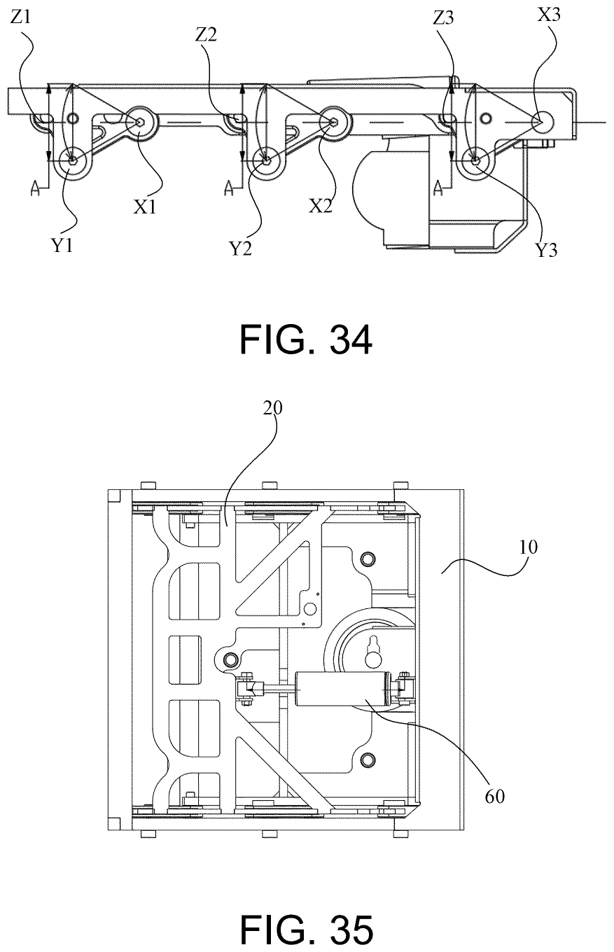

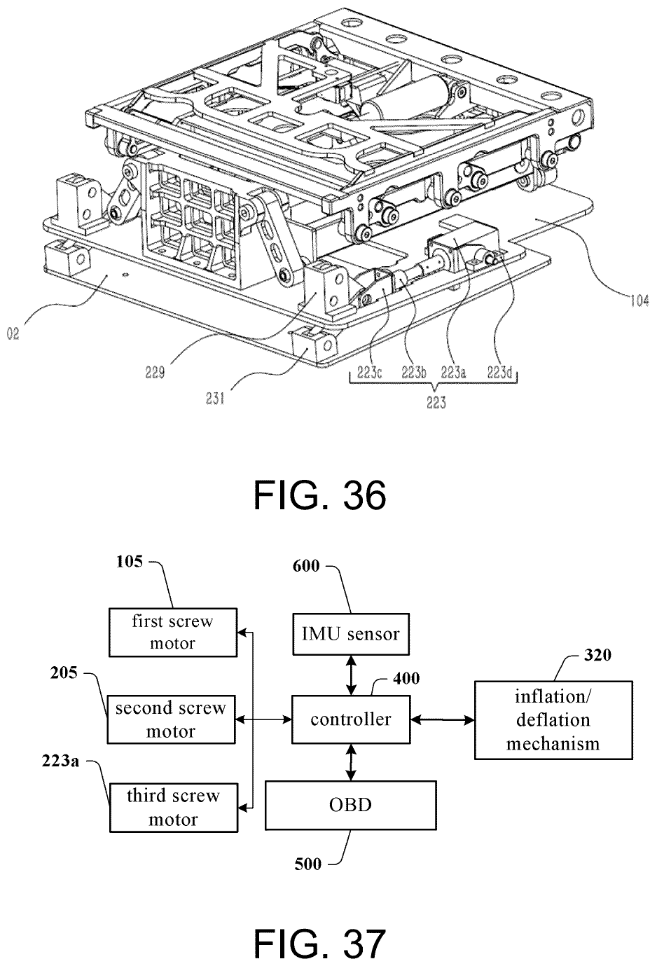

As shown in FIG. 34 and FIG. 35, when the first combined swing arm 3241 and the second combined swing arm 3243 rotate to the lowest shock absorption height position, the secondary connecting rod frame 322 moves vertically downward, driving the upper mounting frame 321 to move to the lowest height position. At this time, the distance between the highest shock absorption height position and the lowest shock absorption height position of the swing arm assembly 324 is A (as shown in FIG. 34).

The secondary connecting rod frame 322 provided in the multi-link parallel shock absorbing mechanism can synchronously connect the top ends of the first combined swing arms 3241 and the second combined swing arms 3243 to the axis of the middle surface of the shock absorbing amplitude, and the left and right are connected, so that all the first combined swing arms 3241 and the second combined swing arms 3243 swing synchronously in the same direction without causing any strange phenomenon.

The structure of the secondary connecting rod frame 322 ensures that the directions of the connecting rod movements of multiple sets of parallel first combined swing arms 3241 and second combined swing arms 3243 are consistent when they reach the central plane (i.e., the middle plane of the shock absorbing amplitude), thereby avoiding the singularity of the swing arm movement (i.e., the uncertainty of the movement direction).

To sum up, the multi-link parallel shock absorbing mechanism of this embodiment realizes stable vertical shock absorbing movement by rotatably connecting (e.g., hingedly connecting) the third ends of the first and second combined swing arms, which are composed of a plurality of connecting rods connected in parallel on both sides, to a platform (i.e., the secondary connecting rod frame 20) that can move approximately vertically.

The multi-link parallel shock-absorbing mechanism adopts pairs of multiple parallel swing arms of the same size to move synchronously. At the same time, at least two pairs of the first combined swing arms are connected to the left and right by torsion bars, making the vertical movement platform very stable. Compared with the scissors-type mechanism, it is more stable and can effectively prevent shaking.

According to the above structural description, as shown in FIGS. 3 to 6, the present disclosure also provides an adaptive robot in another embodiment, which includes the multi-link parallel shock absorbing mechanism 300b as described above. For example, the multi-link parallel shock absorbing mechanism is used for vehicle-mounted passive shock absorption. The basic concepts have been described above. Obviously, for those skilled in the art, the above disclosure is only used as an example and does not constitute a limitation on the present disclosure. Although it is not explicitly stated here, those skilled in the art may make various modifications, improvements and corrections to the present disclosure. Such modifications, improvements and corrections are suggested in the present disclosure, so such modifications, improvements and corrections still belong to the spirit and scope of the exemplary embodiments of the present disclosure.

As shown in this disclosure, unless the context clearly indicates an exception, the words “a”, “an”, “a kind” and/or “the” do not refer to the singular, but also include the plural. Generally speaking, the terms “include” and “comprise” only indicate the inclusion of the steps and elements that have been clearly identified, and these steps and elements do not constitute an exclusive list, and the method or device may also include other steps or elements.

Unless otherwise specifically stated, the relative arrangement, numerical expressions and numerical values of the parts and steps set forth in these embodiments do not limit the scope of the present disclosure. Meanwhile, it should be understood that, for ease of description, the sizes of the various parts shown in the accompanying drawings are not drawn according to actual proportional relationships. The technology, methods and equipment known to those of ordinary skill in the relevant art may not be discussed in detail, but in appropriate cases, the technology, methods and equipment should be considered as a part of the specification. In all examples shown and discussed here, any specific value should be interpreted as being merely exemplary, rather than as a limitation. Therefore, other examples of exemplary embodiments may have different values. It should be noted that similar reference numerals and letters represent similar items in the following drawings, and therefore, once a certain item is defined in an accompanying drawing, it does not need to be further discussed in subsequent drawings.

In the description of the present disclosure, it should be understood that the directions or positional relationships indicated by directional words such as “front, back, up, down, left, right”, “lateral, vertical, perpendicular, horizontal” and “top, bottom” are usually based on the directions or positional relationships shown in the drawings. They are only for the convenience of describing the present disclosure and simplifying the description. Unless otherwise specified, these directional words do not indicate or imply that the devices or elements referred to must have a specific direction or be constructed and operated in a specific direction. Therefore, they cannot be understood as limiting the scope of protection of the present disclosure. The directional words “inside and outside” refer to the inside and outside relative to the contours of each component itself.

For ease of description, spatially relative terms such as “above”, “above”, “on the upper surface of”, “above”, etc. may be used here to describe the spatial positional relationship between a device or feature and other devices or features as shown in the figure. It should be understood that spatially relative terms are intended to include different orientations of the device in use or operation in addition to the orientation described in the figure. For example, if the device in the accompanying drawings is inverted, the device described as “above other devices or structures” or “above other devices or structures” will be positioned as “below other devices or structures” or “below other devices or structures”. Thus, the exemplary term “above” can include both “above” and “below”. The device can also be positioned in other different ways (rotated 90 degrees or in other orientations), and the spatially relative descriptions used here are interpreted accordingly.

In addition, it should be noted that the use of words such as “first” and “second” to define components is only for the convenience of distinguishing the corresponding components. If not otherwise stated, the above words have no special meaning and cannot be understood as limiting the scope of protection of this disclosure. In addition, although the terms used in this disclosure are selected from well-known and commonly used terms, some terms mentioned in the specification of this disclosure may be selected by the applicant at his or her discretion, and their detailed meanings are explained in the relevant parts of the description of this article. In addition, it is required to understand this disclosure not only by the actual terms used, but also by the meaning implied by each term.

It should be understood that when a component is referred to as being “on another component,” “connected to another component,” “coupled to another component,” or “contacting another component,” it may be directly on, connected to, coupled to, or contacting the other component, or there may be intervening components. In contrast, when a component is referred to as being “directly on another component,” “directly connected to,” “directly coupled to,” or “directly contacting” another component, there are no intervening components. Similarly, when a first component is referred to as being “electrically in contact with” or “electrically coupled to” a second component, there is an electrical path between the first component and the second component that allows current to flow. The electrical path may include capacitors, coupled inductors, and/or other components that allow current to flow, even without direct contact between conductive components.

At the same time, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that “one embodiment” or “an embodiment” or “an alternative embodiment” mentioned twice or multiple times in different positions in this specification does not necessarily refer to the same embodiment. In addition, some features, structures or characteristics in one or more embodiments of the present disclosure can be appropriately combined.

Some aspects of the present disclosure may be performed entirely by hardware, entirely by software (including firmware, resident software, microcode, etc.), or by a combination of hardware and software. The above hardware or software may be referred to as “data blocks”, “modules”, “engines”, “units”, “components” or “systems”. The processor may be one or more disclosure specific integrated circuits (ASICs), digital signal processors (DSPs), digital signal processing devices (DAPDs), programmable logic devices (PLDs), field programmable gate arrays (FPGAs), processors, controllers, microcontrollers, microprocessors, or combinations thereof. In addition, various aspects of the present disclosure may be represented as computer products located in one or more computer-readable media, which include computer-readable program codes. For example, computer-readable media may include, but are not limited to, magnetic storage devices (e.g., hard disks, floppy disks, tapes . . . ), optical disks (e.g., compact disks CDs, digital versatile disks DVDs . . . ), smart cards, and flash memory devices (e.g., cards, sticks, key drives . . . ).

Similarly, it should be noted that in order to simplify the description of the disclosure of this disclosure and thus help understand one or more embodiments of the disclosure, in the above description of the embodiments of the present disclosure, multiple features are sometimes combined into one embodiment, figure or description thereof. However, this disclosure method does not mean that the subject of the present disclosure requires more features than the features mentioned. In fact, the features of the embodiment are less than all the features of the single embodiment disclosed above.

In some embodiments, the numbers describing the components and the number of attributes are used. It should be understood that such numbers used for the description of the embodiments are modified by the modifiers “about”, “approximately” or “substantially” in some examples. Unless otherwise specified, “about”, “approximately” or “substantially” indicate that the numbers allow a change of +20%. Accordingly, in some embodiments, the numerical parameters used in the specification are approximate values, which can be changed according to the required characteristics of the individual embodiments. In some embodiments, the numerical parameters should consider the significant digits specified and adopt the method of retaining the general digits. Although the numerical domains and parameters used to confirm the breadth of the range in some embodiments of the present disclosure are approximate values, in a specific embodiment, the setting of such numerical values is as accurate as possible within the feasible range.

Although the present disclosure has been described with reference to the current specific embodiments, ordinary technicians in this technical field should recognize that the above embodiments are only used to illustrate the present disclosure, and various equivalent changes or substitutions may be made without departing from the spirit of the present disclosure. Therefore, as long as the changes and modifications to the above embodiments are within the essential spirit of the present disclosure, they will fall within the scope of the present disclosure.

What is claimed is:

1. An adaptive robot for vehicles, comprising an active centrifugal force counteracting structure and a controller, wherein,
the active centrifugal force counteracting structure comprises a first base plate, a support seat, a swing frame, multiple swing arms and a first screw motor assembly, wherein a lower side of the support seat is suitable for being fixedly mounted on the first base plate, an upper side of the support seat is provided with a first mounting seat, an outer side of the swing frame is provided with a plurality of pin shafts, one end of each swing arm is rotatably connected to one of the pin shafts of the swing frame, the other end of each swing arm is rotatably connected to the first mounting seat, the first screw motor assembly is mounted on the first base plate and comprises a first screw motor, a movable end of the first screw motor assembly is connected to the swing frame, and the first screw motor assembly is configured to drive the swing frame to perform a rolling motion according to a first control signal sent by the controller to compensate for a centrifugal force;
the controller is configured to: obtain current vehicle posture data, determine a driving scene of the vehicle according to the vehicle posture data, and when the driving scene is a sharp turn, send the first control signal, the first control signal including an expected rotational speed of the first screw motor; wherein the controller calculates the expected rotational speed of the first screw motor includes:
calculating an expected compensation angle of the centrifugal force according to the driving scene and the vehicle posture data;
calculating an angle between a first swing arm located on one side of the swing frame and ground according to the expected compensation angle and a kinematic equation of the active centrifugal force counteracting structure among the swing arms;
calculating a moving pair length of the first screw motor assembly according to the angle between the first swing arm and the ground and an installation position of the first screw motor; and
calculating an expected rotational speed of the first screw motor according to the moving pair length of the first screw motor assembly, the angle between the first swing arm and the ground and the expected compensation angle.

2. The adaptive robot of claim 1, wherein the angle θ₁ between the first swing arm and the ground is calculated by following formula:
$${θ}_{1} = arctan ( \frac{{k}_{1} {k}_{2} \pm \sqrt{{k}_{1}^{2} {k}_{2}^{2} - ( {k}_{3} - {k}_{1}^{2} ) ( {k}_{3} - {k}_{2}^{2} )}}{( {k}_{3} - {k}_{1}^{2} )} )$$
wherein,
$${k}_{1} = c sin α , {k}_{2} = c cos α - a , {k}_{3} = \frac{{( {k}_{1}^{2} + {k}_{2}^{2} )}^{2}}{4 {b}^{2}} ,$$
wherein, a is a distance between adjacent first mounting seats, b is a length of the multiple swing arms, c is a distance between adjacent pin shafts, a is the expected compensation angle, wherein the multiple swing arms, an upper side of the support seat and the swing frame constitute a four-bar linkage of the active centrifugal force counteracting structure.

3. The adaptive robot of claim 2, wherein the moving pair length l_{CF} of the first screw motor assembly is calculated by following formula:
$${l}_{CF} = \sqrt{{( b sin {θ}_{1} + {x}_{0} )}^{2} + {( b cos {θ}_{1} + {y}_{0} )}^{2}}$$
wherein, x₀ and y₀ are respectively a horizontal coordinate and a vertical coordinate of a rotation axis of the first screw motor in a coordinate system with the first mounting seat as the origin.

4. The adaptive robot of claim 3, wherein the expected rotational speed n_{d1} of the first screw motor is calculated by following formulas:
$${n}_{d 1} = \frac{2 π {\dot{l}}_{CF}}{D}$$
$${\dot{l}}_{CF} = \frac{{dl}_{CF}}{dt} = \frac{{dl}_{CF}}{d {θ}_{1}} \frac{d {θ}_{1}}{d α} \frac{d α}{dt}$$
wherein, d(·) represents a differential operator, and D is a screw lead.

5. The adaptive robot of claim 1, wherein the first screw motor assembly further comprises a first screw nut, a first motor base, and a first nut seat;
wherein, the first screw motor is fixed on the first base plate through the first motor base, the first screw motor is rotatably connected to the first screw nut, the first screw nut is connected to the swing frame through the first screw nut seat, and the first screw motor is configured to drive the first screw nut to move linearly along a direction perpendicular to a travel direction of the vehicle according to the first control signal, and drive the swing frame to perform the rolling motion to compensate for the centrifugal force.

6. The adaptive robot of claim 1, wherein a distance between adjacent first mounting seats is smaller than a distance between adjacent pin shafts, so that an intersection of direction extension lines of the multiple swing arms is a rotation center of the active centrifugal force counteracting structure, and a height of the rotation center is greater than or equal to a center of gravity of a human body sitting on a seat.

7. The adaptive robot of claim 6, wherein a distance between adjacent first mounting seats is 170 mm˜200 mm, and a distance between adjacent pin shafts is 270 mm˜290 mm.

8. The adaptive robot of claim 1, further comprising a semi-active shock absorbing structure, which is arranged on the active centrifugal force counteracting structure, wherein the semi-active shock absorbing structure is a multi-link parallel shock absorbing mechanism, wherein the multi-link parallel shock absorbing mechanism comprises an upper mounting frame, a secondary connecting rod frame, a base lower frame and at least two sets of swing arm assemblies connected in parallel with each other, wherein multiple ends of the swing arm assembly are rotatably connected to the base lower frame, the upper mounting frame and the secondary connecting rod frame, respectively;
the multi-link parallel shock absorbing mechanism enabling the swing arm assembly to swing synchronously in same direction through the secondary connecting rod frame, thereby realizing a vertical shock absorbing movement of the upper mounting frame.

9. The adaptive robot of claim 8, wherein each set of the swing arm assemblies includes two pairs of a first combined swing arm and a torsion bar, the torsion bar is installed at an end of the base lower frame, and a first end of the first combined swing arm is rotatably connected to two ends of the torsion bar respectively.

10. The adaptive robot of claim 9, wherein a second end of the first combined swing arm is rotatably connected to two ends of the upper mounting frame, and a third end of the first combined swing arm is rotatably connected to two ends of the secondary connecting rod frame.

11. The adaptive robot of claim 9, wherein the first combined swing arm comprises three connecting rods, which are connected in sequence to form a triangular structure, and two connecting rods located at a second end of the first combined swing arm are perpendicular to each other.

12. The adaptive robot of claim 9, wherein the multi-link parallel shock absorbing mechanism also includes at least one pair of second combined swing arms, first ends of each pair of the second combined swing arms are respectively rotatably connected to the base lower frame, second ends of the second combined swing arms are respectively rotatably connected to two ends of the upper mounting frame, and third ends of the second combined swing arms are respectively rotatably connected to two ends of the secondary connecting rod frame.

13. The adaptive robot of claim 9, wherein the multi-link parallel shock absorbing mechanism further comprises an airbag, which is installed at a bottom of the upper mounting frame to directly apply thrust to the upper mounting frame.

14. The adaptive robot of claim 13, wherein the controller is further configured to control a total amount of air in the airbag according to a weight of a passenger on a seat surface to ensure a personalized riding comfort of the passenger.

15. The adaptive robot of claim 8, wherein the multi-link parallel shock absorbing mechanism further comprises a magnetorheological damper, and the magnetorheological damper is horizontally arranged and installed between the upper mounting frame and the secondary connecting rod frame.

16. The adaptive robot of claim 8, further comprising an inertial force counteracting structure, and the controller is further configured to send a second control signal when the driving scene is emergency braking or emergency acceleration, and the inertial force counteracting structure is configured to drive the active centrifugal force counteracting structure, the semi-active shock absorbing structure and a seat surface to perform pitch motion according to the second control signal to absorb the inertial force.

17. The adaptive robot of claim 16, wherein the inertial force counteracting structure comprises: a second base plate, a pitch shaft seat, a pitch shaft, and a second screw motor assembly;
the second base plate and the first base plate are rotatably connected through the pitch shaft seat and the pitch shaft, a fixed end of the second screw motor assembly is connected to the second base plate, a movable end of the second screw motor assembly is connected to the first support seat, and the first support seat is fixedly connected to the first base plate;
the second screw motor assembly is configured to drive the active centrifugal force counteracting structure to perform pitch motion according to a second control signal.

18. The adaptive robot of claim 17, wherein the second screw motor assembly comprises a second screw motor, a second screw nut, a nut rotating plate, and a rotating plate shaft seat;
the second screw motor is rotatably connected to the second screw nut, and the second screw nut is mounted on the rotating plate shaft seat through the nut rotating plate, and the rotating plate shaft seat is mounted on the first support seat, the second screw motor is configured to drive the second screw nut to perform linear motion along a normal direction of the second base plate according to the second control signal, thereby driving the active centrifugal force counteracting structure to perform pitch motion to absorb the inertial force during impact.

19. The adaptive robot of claim 18, wherein the second screw motor assembly further comprises a second motor bracket, a motor swing shaft, and a swing shaft seat;
wherein, the second screw motor is arranged on the second motor bracket, and the second motor bracket is fixed to the second bottom plate through the motor swing shaft and the swing shaft seat.

20. The adaptive robot of claim 18, wherein the inertial force counteracting structure comprises a second base plate, a base plate shaft seat, a third screw motor assembly, a first pitch swing arm, a second pitch swing arm, a first swing arm shaft seat and a second swing arm shaft seat, the second base plate and the first base plate are rotatably connected through the base plate shaft seat, the third screw motor assembly is arranged on the first base plate or the second base plate, the first swing arm shaft seat is arranged on the first base plate, the second swing arm shaft seat is arranged on the second base plate, the first pitch swing arm is connected between the third screw motor assembly and the first swing arm shaft seat, and the second pitch swing arm is connected between the third screw motor assembly and the second swing arm shaft seat.

21. The adaptive robot of claim 20, wherein the third screw motor assembly comprises a third screw motor, a third screw nut, a screw nut mounting seat, and a motor swing seat;
the third screw motor is arranged on the first base plate or the second base plate through the motor swing seat, the third screw motor is rotatably connected to the third screw nut, the third screw nut is arranged on the screw nut mounting seat, and the first pitch swing arm and the second pitch swing arm are rotatably connected to the screw nut mounting seat, and the third screw motor is configured to drive the third screw nut to perform a linear motion along an extension direction of the first base plate according to a third control signal, driving an angle between the first pitch swing arm and the second pitch swing arm to open or close, thereby driving the active centrifugal force counteracting structure to perform a pitch motion.

22. The adaptive robot of claim 20, wherein the controller is further configured to send a second control signal when the driving scene of the vehicle is emergency braking or emergency acceleration, and the second control signal includes an expected speed of the third screw motor; the controller is also configured to calculate the expected speed of the third screw motor, including:
calculating an expected pitch angle based on the vehicle posture data;
calculating a moving pair length of the third screw motor assembly according to the expected pitch angle and a kinematic equation of the inertial force counteracting structure;
calculating a moving pair motion speed of the third screw motor assembly according to the moving pair length of the third screw motor assembly; and
calculating an expected rotational speed of the third screw motor according to the moving pair motion speed of the third screw motor assembly.

23. The adaptive robot of claim 22, wherein the moving pair length IBD of the third screw motor assembly is calculated by following formula:
$${l}_{BD} = \sqrt{\begin{matrix}{a}^{2} + {d}^{2} - 2 ad cos ( arccos \frac{e - c cos β}{\sqrt{{c}^{2} + {e}^{2} - 2 ce cos β}} - \\ arccos \frac{{c}^{2} + {e}^{2} + {a}^{2} - {b}^{2} - 2 ce cos β}{2 a \sqrt{{c}^{2} + {e}^{2} - 2 ce cos β}} )\end{matrix}}$$
wherein, a is a length of the second pitch swing arm, b is a length of the first pitch swing arm, c is a distance from the first swing arm shaft seat on the first base plate to the base plate rotating shaft seat, d is a distance from the second swing arm shaft seat on the second base plate to the motor swing shaft seat, e is a distance from the second swing arm shaft seat on the second base plate to the base plate rotating shaft seat, and β is the expected pitch angle.

24. The adaptive robot of claim 23, wherein the expected rotational speed of the third lead screw motor is calculated by following formula:
$${n}_{d 3} = \frac{2 π {\dot{l}}_{BD}}{D}$$
wherein, D is a screw lead of the third screw motor, i_{BD} is the moving pair speed motion speed of the third screw motor assembly.

25. The adaptive robot of claim 18, wherein the controller is further configured to send a second control signal when the driving scene of the vehicle is emergency braking or emergency acceleration, and the second control signal includes an expected speed of the second screw motor;
the controller is also configured to calculate the expected rational speed of the second screw motor, including:
calculating an expected pitch angle based on the vehicle posture data;
calculating an expected position of the second screw nut according to the expected pitch angle and a kinematic equation of the inertial force counteracting structure;
calculating the expected rotational speed of the second screw motor according to the expected position of the second screw nut and the expected pitch angle.

26. The adaptive robot of claim 25, wherein the expected position of the second screw nut is calculated by following formula:
$${l}_{LN} = \sqrt{{l}^{2} + {n}^{2} - 2 nl cos β}$$
wherein, l_{LN} is a length from the second screw nut to a rotation axis of the second screw motor, l is a length from the rotation axis of the second screw motor to a pitch axis, nis a length from the pitch axis to the second screw nut, and β is the expected pitch angle.

27. The adaptive robot of claim 1, wherein the vehicle posture data includes longitudinal vehicle speed, steering wheel angle, brake pedal signal and corrected longitudinal acceleration,
wherein, the corrected longitudinal acceleration is calculated using following formula:
$${a}_{t} ( k ) = {ha}_{y} ( k ) + ( 1 - h ) \frac{{v}_{y} ( k ) - {v}_{y} ( k - 1 )}{Δ t}$$
wherein, aₜ(k) is the corrected longitudinal acceleration, a_{y}(k) is the longitudinal acceleration obtained from an IMU sensor, v_{y}(k) is the longitudinal vehicle speed at current moment obtained from on-board automatic diagnostic system, v_{y}(k−1) is the longitudinal vehicle speed at previous moment, Δt is a sampling interval, and h is a complementary filter coefficient, which takes a value between 0 and 1.

28. The adaptive robot of claim 27, wherein determining the driving scene of the vehicle according to the vehicle posture data comprises:
when the longitudinal vehicle speed is less than or equal to a first threshold value, and the steering wheel angle is greater than a second threshold value, determining that the driving scene of the vehicle is a sharp turn;
when the brake pedal signal exists and the corrected longitudinal acceleration is greater than a third threshold, determining that the driving scene of the vehicle is an emergency brake;
when the brake pedal signal does not exist and the corrected longitudinal acceleration is greater than a fourth threshold, determining that the driving scene of the vehicle is an emergency acceleration.

29. An inertial force counteracting structure, comprising: a second base plate, a pitch shaft seat, a pitch shaft and a second screw motor assembly;
the second base plate and the first base plate are rotatably connected through the pitch shaft seat and the pitch shaft, a fixed end of the second screw motor assembly is connected to the second base plate, a movable end of the second screw motor assembly is connected to the first support seat, and the first support seat is fixedly connected to the first base plate;
the second screw motor assembly is configured to drive the active centrifugal force counteracting structure to perform pitch motion according to a second control signal.

30. A multi-link parallel shock absorbing mechanism, comprising an upper mounting frame, a secondary connecting rod frame, a base lower frame and at least two sets of swing arm assemblies connected in parallel with each other, wherein multiple ends of the swing arm assembly are rotatably connected to the base lower frame, the upper mounting frame and the secondary connecting rod frame, respectively,
the multi-link parallel shock absorbing mechanism enabling the swing arm assembly to swing synchronously in same direction through the secondary connecting rod frame, thereby realizing the vertical shock absorbing movement of the upper mounting frame.
